(19) United States
(12) Patent Application Publication
(10) Pub. No.: US 2019/0095992 A1
(43) Pub. Date: Mar. 28, 2019

(54) METHOD AND SYSTEM TO FACILITATE DECENTRALIZED MONEY SERVICES SOFTWARE AS A SERVICE

(71) Applicant: Annie Mafotsing Soh, Breinigsville, PA (US)

(72) Inventor: Annie Mafotsing Soh, Breinigsville, PA (US)

(21) Appl. No.: 15/822,278

(22) Filed: Nov. 27, 2017

Related U.S. Application Data
(60) Provisional application No. 62/562,441, filed on Sep. 24, 2017.

(51) Int. Cl. G06Q 40/04; G06Q 20/38

(52) U.S. Cl. CPC G06Q 40/04; G06Q 20/381

(57) ABSTRACT

A data management system for processing data collected from a plurality of money services businesses servers and market exchange rate platform. The data management system comprising a communication interface communicatively coupled with said plurality of systems hosted at remote servers locations. The communication interface may be configured to receive, from said plurality of systems; data based on input search parameters and store said data in storage. The data management system may comprise an analytics computing platform operatively coupled with data storages over a communication network. The said data storages hold a dataset comprising money services business data, total amount received per dollar index data and market exchange rate data. The analytics computing platform may employ a big data processing framework to stream the dataset and a production machine learning algorithm to analyze the said dataset vis-à-vis a matrix of features to predict money services business data price movements.

### CROSS-REFERENCE TO RELATED APPLICATIONS

This application incorporates by reference and claims the benefit of priority to U.S. Provisional Patent Application No. 62/562,441 filed Sep. 24, 2017.

### BACKGROUND OF THE INVENTION

Cross-border money transfers or remittances are very popular among members of the expatriates communities and diaspora (immigrants living abroad) who regularly send money to families, relatives or their native communities overseas. Money transfer transactions are typically executed in a traditional brick-and-mortar place through authorized money services businesses' cash agents. People searching for money transfer solutions typically visit the authorized cash agents' stores to execute their transactions.

However, money services businesses such as money transfer operators, banks, and mobile wallet operators are providing digital cross-border money transfer services through their online platforms to digitalize the money transfer transactions for customers, thus expanding their digital money transfer services presence. Money services businesses display their cost profile (cost and other attributes for sending money and/or receiving money to destination countries) via their online platforms to give users insights in the cost of sending money abroad digitally. Money transfer participants (senders and recipients) visit each provider's online platform to search and compare these providers' costs for the best value for their transactions.

Each money services business sets its own exchange rate, transfer fee, pay-in options (bank deposit, credit card, debit card, money order, cash, cryptocurrency, prepaid cards), pay-out options (bank deposit, cash pickup, mobile money, mobile airtime, door delivery), total cost to sender, total amount received, speed of fund delivery based on the destination countries and the amount sent to or received by recipients. The money services businesses don't disclose the foreign currency exchange rate margin realized from cross-border money transfer transactions compared to the real-time market exchange rate from major exchange rate platforms; thus realizing maximum profit in each transaction with a foreign currency.

Should the details of the foreign currency exchange margins become widely known, money transfer participants can then actively shop for the money services business with the best rate for their transactions. For this reason, the money services businesses do not disclose their margins and change them as they see profitable for their enterprise. Due to the lack of transparency and the volatility of foreign exchange currencies margins in money transfer transactions, money transfer participants are relentlessly looking for ways to determine the cost of sending money from their current location and/or receiving money to a foreign destination country at a specific time period as services to minimize the total cost to send money and maximize the total amount received at destination.

There is, however, a lack of economic value insights to connect all key major money services businesses to the money transfer participants. Thus, there is a need for a decentralized “Money Transfer as a Service” from heterogeneous money services businesses data sources to provide money transfer participants with data insights into the real-time cost of sending money and/or receiving money to foreign destination countries based on search input parameters values. In addition, the need to provide predictive data to forecasting the price movement of total cost to send money, total amount received, the predicted exchange rate and transfer fee when sending money from a money service business at a specific point in time within a specified corridor will benefit the money transfer community as a whole.

### BRIEF SUMMARY OF THE INVENTION

The present disclosure relates to the art of real-time data collection, aggregation, standardization, storage, data processing, machine learning, data mining and artificial intelligence of money services businesses data, market exchange rate data in order to automate human-decision making process in money transfer activities and to provide key data insights via business intelligence analytics and visualization to the money transfer community. The disclosure further relates to a cloud based predictive analytics platform of money services businesses data to predict the price movement of money services businesses key attributes such as total cost to send money, total amount received, exchange rate, transfer fee, and the trend of total cost to send at a given time period within a corridor based on input search parameters.

According to a first aspect, a data management system comprising: first, a scraping method to collect data from one or a plurality of money services businesses' servers (physical, online or both) based on input search parameters; to collect the market exchange rates data from remote market exchange rate platform based on input search parameters; second, determining, using a processor, total amount received per dollar index value of each money services business based on input search parameters and said collected money services business data; to store in storages data comprising: said collected money services business data, said collected market exchange rates data, said total amount received per dollar index value data; displaying one or more of: said collected money services business data, said collected market exchange rates data, said total amount received per dollar index value data.

According to a second aspect, the collected money services business data storage, the computed total amount received per dollar index value data storage, and the collected market exchange rates data storage are coupled to a communication network, wherein the communication network communicates said collected money services business data, said total amount received per dollar index value data, and said collected market exchange rates data to an analytics computing platform, wherein the analytics computing platform is facilitated via a cloud computing framework that employs a distributed, fault-tolerant, loosely coupled and scalable file system running on commodity cluster hardware, wherein the analytics computing platform receives said collected money services business data, said total amount received per dollar index value data, said collected market exchange rates data and defines said data as a data set, wherein the data set is sent over a communication network to said analytics computing platform to a messaging system that employs a distributed, high throughput, replicated, fault-tolerant and scalable system running on commodity cluster hardware, wherein the said analytics computing platform employs a production machine learning algorithm to analyze the said data set vis-à-vis a matrix of features to predict money services business data's price movements.

According to a third aspect, the money services business data storage, the total amount received per dollar index value data storage, the market exchange rates data storage, and the predicted price movement data storage are coupled with a communication network to the analytics computing platform, wherein said analytics computing platform employs a big data processing framework to stream the data comprising one or more of: said money services business data, said market exchange rates data, said total amount received per dollar index value data, said predicted price movement data.

The collected data includes one or more of: structured format, semi-structured format, unstructured format.

The money service business data sources are heterogeneous data sources comprising one or more of: money transfer operator, bank, credit union, loan institution, mobile wallet operator, Bus/Courier Company, Hawala Agent, currency dealers or exchangers, payment solution provider, check cashing provider, post office, issuers or sellers of cryptocurrencies, issuers or sellers of traveler's checks or money orders, blockchain sources, digital financial sources, digital economic sources.

The collected data comprises one or more of: money service business name, exchange rate, transfer fee, amount sent, sending currency, amount received, received currency, speed of transfer, money service business geographic pay-out coverage, user reviews, pay-in options, pay-out options, total cost to send, total amount received, request time stamp, market exchange name, market exchange rate, and market exchange rate currency pair (base and quote currencies).

The data management system may comprise a hosting server running on a personal computer, Iot (Internet of Things) device(s), computing mobile device(s), a laptop computer(s), desktop computer(s) or running on a server computer, a series of server computers, a mainframe computer(s) or a computing cloud(s).

The hosting server may be running on commodity cluster hardware using virtualized layer such as, VMWare®™ Workstation Pro, AWS®™ EC2 instance, Microsoft®™ Azure instance or the like. The hardware virtualized layer may execute an operating system, for example, but not limited to, Microsoft®™ Windows; Mac®™ OS X; Linux®™, Oracle®™ Solaris or a custom operating system. The hosting server may be hosted on a cloud service platform, for example, but not limited to, Google®™ Compute Engine, Microsoft®™ Azure, Amazon®™ Web Services. Alternatively, the hosting server may be hosted on-premises, for example, a physical datacenter with local hosting.

In certain aspects, the input search parameters comprise one or more of: destination country, amount sent, sending currency, amount received, receiving currency, destination city.

The input search parameters comprise one or more of: user configurable input search parameters, system configurable input search parameters.

In certain aspects, the display of data to the interface may employ data presentation types comprising one or more of: map charts, line charts, pie charts, area charts, bubble charts, column bars, clustered bars, bar charts, scattered charts, dynamic charts, 3D charts, tree map, HTML code widget, batch data format, table data format, REST API format, streaming data format, graph-based data format.

The display interface comprises one or more of: graphical user interface, web browser interface, command line interface.

In certain aspects, the cloud computing framework is a Platform as a Service (PaaS) or an Infrastructure as a Service (IaaS).

In certain aspects, the cloud computing framework may employ a moderate latency, high throughput and fault-tolerant streaming engine.

In certain aspects, the cloud computing framework may employ a distributed, high throughput, replicated, fault-tolerant messaging system.

In certain aspects, the cloud computing framework is a platform for managing fault-tolerant, loosely-coupled, scalable, redundant and distributed data center infrastructures.

In certain aspects, the cloud computing framework may employ the Apache Hadoop MapReduce parallel processing.

In certain aspects, the production machine learning algorithm is a scalable machine learning algorithm.

### BRIEF DESCRIPTION OF THE DRAWINGS

A detailed description of various embodiments of the present disclosure is provided herein below with reference to the following drawings, in which:

FIG. 1 is a schematic diagram illustrating the user input interface with user configurable input search parameters.

FIG. 2 is a schematic overview of the architecture of the hosting server for real-time data collection, aggregation, standardization, storage and display of money services businesses and market exchange rate platform.

FIG. 3 is a flowchart diagram describing the steps taken to collect, aggregate, store and display money services business data, total amount received per dollar value data, and market exchange rate data.

FIG. 4 is a schematic diagram illustrating the process of streaming the money services business data, computed total amount received per dollar value data, predicted price movement data, and market exchange rates data to the user interface.

FIG. 5 is a flowchart illustrating the steps taken based on the end user's actions from the data management system.

FIG. 6 is a schematic diagram illustrating the workflow of splitting the dataset to train and test the machine learning algorithm to derive a model for predictive analytics.

FIG. 7 is a decision tree schematic used for machine learning binary classification.

FIG. 8 is a system architecture overview of the data management system.

FIG. 9 is an Artificial Neural Network schematic used for deep learning to derive predictive price movements of money services businesses data.

FIG. 10 is an overview of RDD DStreams processed and displayed to the client device's user interface.

FIG. 11 is an overview live dashboard of data visualization charts of end user requests initiated from the data management system to specific destination countries.

FIG. 12 is an overview live dashboard of data visualization line chart of total amount received per dollar value per specific destination countries for specified money services businesses.

FIG. 13 is an overview live dashboard of data prediction visualization (actual and predicted values) of the total cost to send a specific amount value to a specific country using a specific pay-in type on a specific date.

FIG. 14 is an overview live dashboard displaying collected real-time data from decentralized heterogeneous data sources to the user interface based on input search parameters.

FIG. 15 is a schematic overview of the architecture of the analytics computing platform.

FIG. 16 is a schematic overview of the analytics computing platform illustrating the production machine learning and big data streaming processing aspects.

FIG. 17 is an overview live dashboard of graph-data visualization depicting the relationship between an end user's profile and the end user's submitted requests from the data management system.

It will be understood that the drawings are exemplary only and that any reference to them is done for the purpose of illustration only, and is not intended to limit the scope of the embodiments described herein below in any way.

### DETAILED DESCRIPTION OF THE INVENTION

The embodiments of the present disclosure will be described herein below with reference to the figures of the accompanying drawings. In the following description, well-known functions are not described in detail since such descriptions would obscure the present disclosure in unnecessary detail. For the purpose of promoting an understanding of the principles of the claimed technology and presenting its currently understood, mode of operation, reference will be made to the embodiments illustrated in the drawing and specific language will be used to describe the same. It will nevertheless be understood that no limitation of the scope of the claimed technology is thereby intended, with such alterations and further modifications illustrated in these embodiments and such further applications of the principles of the claimed technology as illustrated therein being contemplated as would typically occur to one skilled in the art in which the claimed technology relates.

As utilized herein the terms “e.g”, “such as” and “for example” mean list of one or more non-limiting examples, instances or illustrations.

As utilized herein the term “exemplary” means serving as a non-limiting example, instance or illustration.

The embodiments described herein are not limiting but rather are exemplary only. It should be understood that the described embodiments are not necessarily to be construed as preferred or advantageous over other embodiments. Moreover, the terms “embodiments” or “embodiment” do not require that all embodiments of the present disclosure include the discussed feature, advantage or mode of operation.

The term “communicate” as used herein, includes both conveying data from a source to a destination and delivering data to a communication medium, system, channel, network, device and/or link to be conveyed to a destination. The term “communication” as used herein, means data so conveyed or delivered.

The terms “including”, “comprising” and variations thereof as used herein, mean “including but not limited to”. An enumerated listing of items does not imply that any or all of the items are mutually exclusive and/or mutually inclusive unless expressly specified otherwise. The terms “a”, “an” and “the” also refer to “one or more” unless expressly specified otherwise.

The terms “coupled” and “coupled with” as used herein, each mean a relationship between or among two or more processes, apparatuses, elements, functions, operations, programs, components, media, networks, systems, subsystems and/or means, constituting any one or more of (i) a connection, whether direct or through one or more other processes, functions, apparatuses, elements, functions, operations, programs, media, components, networks, systems, subsystems or means (ii) a communication relationship whether direct or through one or more other processes, functions, apparatuses, elements, functions, operations, programs, media, components, networks, systems, subsystems or means (iii) a functional relationship in which the operation of any one or more processes, functions, apparatuses, elements, functions, operations, programs, media, components, networks, systems, subsystems or means depends, in whole or in part, on the operation of any one or more others thereof.

The term “data” as used herein, means any indicia, signals, marks, symbols, domains, symbol sets, representations or any other forms representing information, whether permanent or temporary, whether visible, audible, acoustic, human readable, machine readable, or otherwise manifested. The term “data” is used to represent predetermined information in an electronic form, encompassing any and all representations of corresponding information in a different electronic form or forms.

The terms “database”, “data store” as used herein, mean an organized body of related data, regardless of the manner in which the data or the organized body thereof is represented. For example, the organized body of related data may be in the form of one or more of a table, map, grid, diagram, frame, file, email, document, report, list, API format, or any other form.

The terms “network”, “communication network” as used herein, include both networks and inter-networks of all kinds, including the internet, intranet, extranet and is not limited to any particular network or inter-network.

The term “processor” as used herein, means processing programs, functions, components, systems, subsystems implemented in tangibly embodied software, computer hardware, virtual machines and whether or not it is programmable.

The term “service” as used herein, means a piece of software which provides functionality to other pieces of software within or external to the system. The other pieces of software include, but are not limited to, one or more website, mobile application, desktop application or another service which uses another service in order to carry out a particular type of functionality. The service provides functionality to these examples.

The term “topic” as used herein, means a specific location where electronic messages are collected or grouped.

The term “broker” as used herein, means a software process or an executable or daemon service that runs on a machine. The broker has access to resources on the machine which it uses to store messages categorized as topics.

The term “cluster” as used herein, means a grouping of multiple servers or a set of connected machines that work together as a single system.

The term “asynchronous” as used herein, means an event based communication where transmission of data, generally is done without the use of an external clock signal and intermittently rather than in a steady stream.

The term “serialization” as used herein, means encoding. For example, message serialization means message content encoding using a defined data type.

The term “corridor” as used herein, means a source country to destination country. For example, ‘USA to Canada’ is a corridor with USA as the source country and Canada as the destination country.

The term “money transfer community” as used herein, encompasses any or all of the following: senders and recipients of money transfer transactions, money transfer data publishers and researchers, money transfer data analysts, money transfer data scientists, money transfer data engineers, money services business participants.

The term “money transfer operator” as used herein, means an authorized, licensed and regulated business that can collect, hold and transmit funds from one person to another or from one account to another, for example, Moneygram®™, Western Union®™, Ria MoneyTransfer®™.

The term “mobile wallet operator” as used herein, means a money transfer operator using P2P (Peer to Peer) model for fund transfer, for example, Paypal®™.

The terms “money services business”, “money services businesses”, “money service business”, “money service businesses” and variations thereof as used herein, mean a regulated or unregulated financial institution (bank or non-bank) that transmits or converts money. For example, banks, mobile wallet operator, money transfer operator, Bus/Courier Company, Hawala Agent, credit union, loan institution, check cashers, issuers or sellers of traveler's checks or money orders, currency dealers or exchangers, payment solution providers, post office, issuers or sellers of cryptocurrencies such as bitcoins, lumens.

The term “check cashing” as used herein, means a brick-and-mortar place where bill payments, money transfer transactions are made over the counter with cash payment through a clerk. For example: Pay-O-Matic®™ Check Cashing, RiteCheck®™.

The term “foreign exchange currency broker” as used herein, means a platform that exchanges one currency to another as a swap, for example, Transferwise®™.

The term “pay-in” or “pay-out” as used herein, means a method of paying or receiving a payout respectively. For example, pay-in options may include, but not limited to cash, bank account, credit card, bitcoins, debit card. Pay-out options may include, but not limited to, cash, mobile wallet credit, bank deposit, home delivery, cryptocurrency, airtime top-up, prepaid card top-up.

The terms “user”, “end user” as used herein, mean any user of the data management system. For example, member of the money transfer community, government agent, research agent, etc.

Aspects of the present disclosure may be embodied as an apparatus, system, method or computer program product. Accordingly, aspects of the present disclosure may take the form of an entirely hardware embodiment, an entirely software embodiment (including firmware, software, micro-code, etc.) or an embodiment combining software and hardware aspects.

Furthermore, aspects of the present disclosure are described herein with reference to schematic flowchart diagrams and/or schematic of methods, apparatuses, systems, and computer program products according to embodiments of the disclosure. It will be understood that aspects of the present disclosure may take the form of a computer program product embodied in one or more computer readable storage media having computer readable program instructions embodied thereon.

These computer readable program instructions may be provided to a processor of a general purpose computer, special purpose computer, other programmable data processing apparatus or other computing/processing devices including, but not limited to mobile devices, smartphone, tablet, such that the instructions, which execute via the processor of the computer or other computing/processing devices, create means for implementing the functions/acts specified in the schematic flowchart diagrams and/or schematic block diagrams block or blocks.

In this regard, each block in the flowchart or schematic diagram may represent a module, segment, or portion of instructions, which comprises one or more executable instructions for implementing the specified logical function(s). Nevertheless, the portion of instructions need not be physically located together, but may comprise disparate instructions stored in different locations which, when joined logically together, comprise the module and achieve the stated purpose for the module.

Any combination of one or more computer readable medium(s) may be utilized. The computer readable storage medium can be a tangible device that can retain and store instructions for use by an instruction execution device. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), static random access memory (SRAM), a Blu-ray disc, an optical storage device, a magnetic tape, a Bernoulli drive, a magnetic disk, a magnetic storage device, a punch card, a digital versatile disk (DVD), a memory stick, a floppy disk, a portable compact disc read-only memory (CD-ROM), integrated circuits, other digital processing apparatus memory devices or any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. In the context of this document, a computer readable storage medium may be any tangible medium that can contain, or store a program for use by or in connection with an instruction execution system, apparatus or device.

Computer readable program instructions described herein can be downloaded to respective computing/processing devices from a computer readable storage medium or an external computer or external storage device via a network, for example, the Internet, a local area network, a wide area network, a wireless network. The network may comprise copper transmission cables, optical transmission fibers, wireless transmission, routers, firewalls, switches, proxy servers, load balancers, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the aspects of this embodiment may be machine instructions, machine dependent instructions, microcode, firmware instructions or either source code or object code written in any combination of one or more programming languages, including an object oriented programming language such as Java, Python, Scala, C++ or the like, and conventional procedural programming languages, such as the “C” programming language or similar programming languages. The computer readable program may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external server (e.g: through the internet using an Internet Service Provider).

The computer readable program instructions may be stored in a computer readable storage medium that can direct a computer, other computing/processing devices, other programmable data processing apparatus or other devices to function in a particular manner, such that the instructions stored in the computer readable storage medium produce an article of manufacture including instructions which implement the function/act specified in the schematic flowchart diagrams and/or schematic block diagrams block or blocks.

The computer readable program instructions may also be loaded onto a computer, other computing/processing devices, other programmable data processing apparatuses, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the figures illustrate the architecture, functionality, and operation of possible implementations of apparatuses, systems, methods and computer program products. It should also be noted that, in some alternative implementations, the functions noted in the block may occur out of the order noted in the figures. For example, two blocks shown in succession may, in fact, be executed substantially concurrently depending upon the functionality involved. Although various arrow types and line types may be employed in the flowchart and/or block diagrams, they are understood not to limit the scope of the corresponding embodiments. Indeed, some arrows or other connectors may be used to indicate only the logical flow of the depicted embodiment. For example, an arrow may indicate a waiting period of unspecified duration between enumerated steps of the depicted embodiment.

It will be noted that the module or portion of instructions may be implemented using microservices. The data management system may use microservices to collect, aggregate, standardize and store the data. Microservices are small services variant of the service-oriented architecture style that structure an application as a collection of loosely coupled, highly concurrent, scalable, technology agnostic, distributed, stateless, flexible, high performant and resilient message-driven services.

The real-time collection, aggregation, standardization and storage of money services businesses' data, using microservices, provides ease to handle failure, aims for decoupling and autonomy, and eases to scale to additional cluster commodity hardware. Microservices may be deployed as software services running on top of commodity hardware. Microservices communicate to each other using language agnostic APIs (Application Programming Interfaces) and may be written in any combination of one or more programming languages, including an object oriented programming language such as Java, Python, Scala or the like, or may be written using functional programming languages such as Erlang, clojure or similar functional programming languages or in any combination of one or more programming languages.

To help the money transfer community monitor the costs of sending specific amount of money to various corridors; a data management system may be employed to collect real-time data from one or a plurality of money services businesses remote servers and market exchange rates platform, and display to the user interface. The data management system enables the money transfer community to digitally receive the real-time rates and fees of money services businesses vis-à-vis search input parameters via client device(s), that include, but is not limited to, a desktop computer(s), a laptop computer(s), IoT (Internet of Things) device(s), mobile computing device(s), a server computer, a series of server computers, a mainframe computer(s) or a computing cloud(s).

Such data management system helps the money transfer community monitor and track the cost of sending specific amount value over periods of time to specific destination countries. For example, the data management system may be used to discover insights into the cost of each provider and thus promoting competition among providers to reduce cost of sending money to various corridors. A simple money transfer information management system is available from the World Bank website; however the data collected is done manually. The data management system thereby eliminates the outdated and often ineffective methods as well as reduces costs of manual data collection and reporting from the money services business brick-and-mortar floors or online platforms. In addition, the data management system may stream the collected data to the user interface of the client device by transmitting data in small sequential micro-batches to be displayed continuously to the user interface as data streams, without user manual intervention.

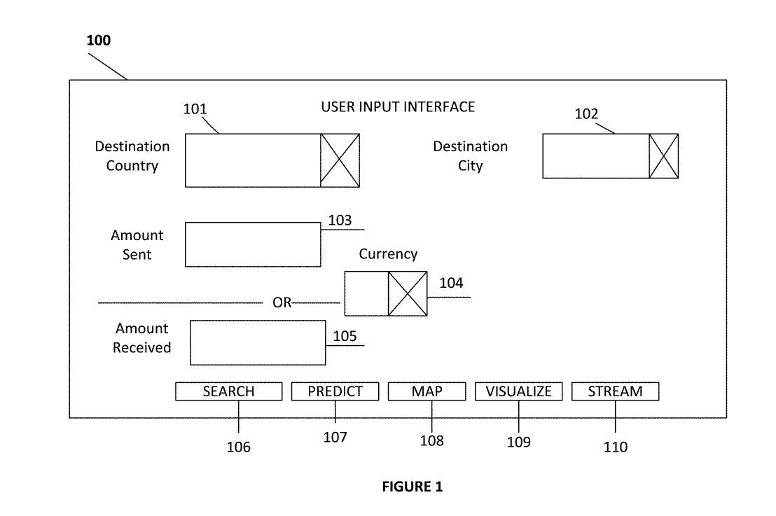

FIG. 1 depicts a schematic diagram illustrating the user input interface with user configurable input search parameters. The user input interface 100 is the front-end of the data management system. The user input interface 100 captures input search parameters and actions. As shown in FIG. 1, the user input interface 100 includes input search parameters comprising: destination country 101, destination city 102, amount sent 103, sending currency 104, amount received 105, receiving currency 104. End user submits values to the input search parameters. The values submitted are used in the real-time data collection of decentralized heterogeneous money services business servers and market exchange rates platform. The user input interface 100 also includes action icons including: search 106, predict 107, map 108, visualize 109, and stream 110. The search icon 106 is used to submit input search requests to remote money services business servers and market exchange rate platform. The predict icon 107 is used to retrieve and display the predicted price movements of money services businesses' data based on submitted input search parameters.

The map icon 108 is used to display the pay-out geo-locations of money services businesses on a map chart. The visualize icon 109 is used to display the collected data and predicted data in visualization formats on a dashboard including, but not limited to, line charts, pie charts, area charts, bubble charts, column bars, clustered bars, bar charts, scattered charts, dynamic charts, 3D charts, tree map, HTML code widget, batch data format, table data format, REST API format. The stream icon 110 is used to stream the real-time data collected and the predicted price movements of money services businesses' data to the user interface.

The input search parameters may be user configurable as illustrated in FIG. 1 and/or system configurable input search parameters. For example, in lieu of sending input search parameters from the user input interface 100, the hosting server may be configured with a scheduling service such as cron job with pre-configured system configurable input search parameters values to periodically automate the data collection process from one or plurality of money service businesses servers and market exchange rate platform.

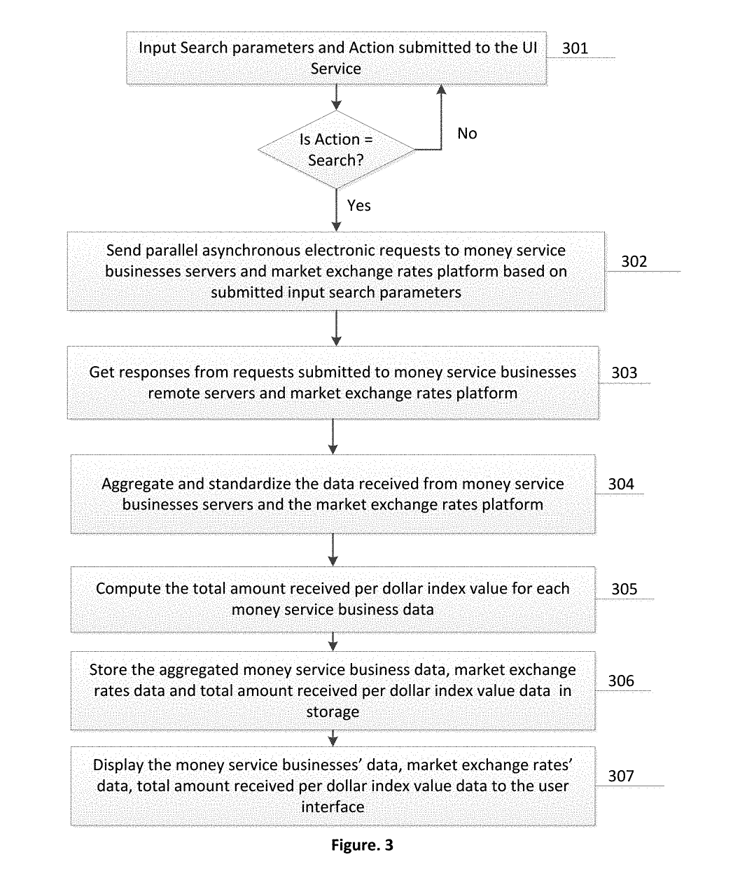

Turning to FIG. 3, the flowchart diagram describes the steps taken to collect, aggregate, store, and display money services business data, total amount received per dollar index value and market exchange rate data. As shown in FIG. 3, in step 301, input search parameters and action event are submitted to the UI (User Interface) service for processing. For example, if action ‘Search’ is selected from the user input interface, values of input search parameters and the ‘Search’ action event are submitted to the UI (User Interface) service. The submission sends parallel asynchronous electronic requests to one or a plurality of money services businesses remote servers and market exchange rates platform to collect data as shown in step 302. Data responses to the electronic requests are received by the hosting server as shown in step 303.

In step 304, the collected data from money service business servers is aggregated. The collected data may be received in a structured format, semi-structured format, unstructured format or any combination thereof. The collected data is standardized to a structured format by data type.

For example, Equation 1 below illustrates a sample single observation data response standardized from a request to one money services business.

[msb ‘Business Name, Exchange Rate, Transfer Fee, Amount Sent, Sending Currency, Amount Received, Origin Country, Destination Country, Receiving Currency, Request time stamp, pay-in type, pay-out type’, msb ‘Moneygram®™, 65.23, 2, 100, USD, 6523, USA, India, INR, 20171104023012, bank account, cash pickup’] Equation 1:

While Equation 2 below, for example, illustrates a sample single observation response standardized from a request to the market exchange rate platform.

[marketRate ‘Name, Request time stamp, [{Exchange Rate, Currency}]’, marketRate ‘XE®™, 20171104023012, [{6.59, CNY},{1, USD},{0.83, EUR},{1.25, AUD},{0.737, GBP}]’] Equation 2:

In step 305, the collected data is used to compute the total amount received per dollar index value for each money services business. In step 306, the aggregated money services businesses' data, market exchange rates data and computed total amount received per dollar index value data are stored in storage. The aggregated data from money services businesses servers, market exchange rate platform and computed total amount received per dollar index value data are displayed to the client device's user interface as shown in step 307.

The flowchart schematic diagram steps shown in FIG. 3 depicts the steps taken by the data management system for real-time data collection, aggregation, standardization and storage of decentralized heterogeneous money service business data sources and market exchange rate platform. These steps are similar to an ETL (Extract-Transform-Load) software tool that extracts data from heterogeneous sources, aggregates, standardizes and stores in a data store, repository, vault, or data warehouse. The decentralized heterogeneous money services businesses data sources comprise one or more of: money transfer operator, bank, credit union, loan institution, mobile wallet operator, Bus/Courier Company, Hawala Agent, currency dealers or exchangers, payment solution provider, check cashing provider, post office, issuers or sellers of cryptocurrencies, issuers or sellers of traveler's checks or money orders, blockchain sources, digital financial sources, digital economic sources.

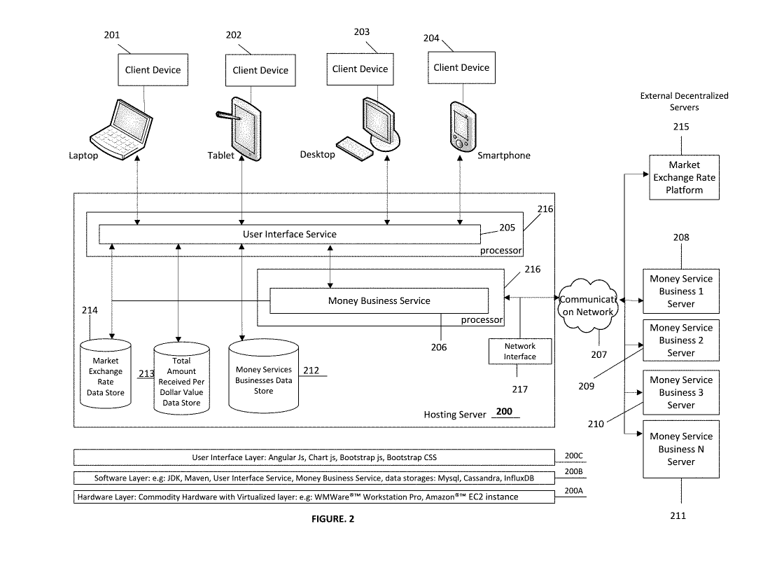

Turning to FIG. 2, the schematic overview of the architecture of the hosting server for real-time data collection, aggregation, standardization, storage and display of money services businesses and market exchange rate platform. As shown in FIG. 2, the data management system includes a hosting server 200. The hosting server 200 includes a hardware layer 200A, a software layer 200B and a user interface layer 200C. The hardware layer 200A includes the commodity hardware with virtualized layer, for example, VMWare®™ Workstation Pro or Amazon®™ EC2 instance. Layer 200A may run an operating system, for example, Linux®™ operating system. The hardware layer 200A has at least 2 processors 216 and may have, for example, 64 GB RAM memory and at least 220 GB of disk storage. The software layer 200B runs on top of the hardware layer 200A. The software layer 200B includes JDK, Maven libraries, microservices 205, 206 and data storages 212, 213, 214 needed to store the collected data from decentralized heterogeneous money service business servers 208, 209, 210, 211, the exchange rate platform 215 and the computed total cost per dollar index value data.

The user interface layer 200C handles the data presentation to the user interface of client devices 201, 202, 203, 204. The user interface layer 200C includes javascript front-end framework such as Angular js, bootstrap js, Chart js, bootstrap css. The hosting server 200 may be hosted on a cloud service platform, for example, but not limited to, Google®™ Compute Engine, Microsoft®™ Azure, Amazon®™ Web Services. Alternatively, the hosting server 200 may be hosted on-premises, for example, on a personal computer, with local hosting. The processors 216 process the real-time data collection, aggregation, storage, and display of data using User Interface Service 205 and Money Business Service 206. The User Interface Service 205 and Money Business Service 206 are running on the software layer 200B. External decentralized servers include the remote heterogeneous money services businesses servers 208, 209, 210, 211 and the market exchange rate platform 215. The microservice, Money Business Service 206, uses the network interface 217 to collect data from the remote money service business servers 208, 209, 210, 211 and remote market exchange platform 215 over a communication network 207.

The communication network 207 may include, but not limited to, HTTPS (HyperText Transfer Protocol), FTP (File Transfer Protocol), SFTP (SSH File Transfer Protocol), Representational State Transfer (REST) architecture, Remote Procedure Calls (RPCs), wifi, Ethernet, LTE cellular, LAN, WAN, Ethereum blockchain, etc. The communication network may contain switches, routers, VPNs, gateways, firewalls, proxy servers, load balancers, subnets and other networking means. The communication network 207 may incorporate cybersecurity means such as the blockchain obfuscation technology, SSL, TLS, secured REST API interfaces, user authentication and authorization using LDAP, SAML 2, OpenId, or OAUth. The data storages 212, 214 store respectively the collected money services business data, and the market exchange rate data.

The User Interface Service 205 provides the user input interface. The front-end module of the user interface service 205 may, for example, use a Single-Page Application (SPA) using javascript framework such as AngularJs, Node.js or any open source web framework for data presentation. The backend of the User Interface Service 205 serves user and/or system input search parameters values. The said backend of the user interface service communicates with the Money Business Service 206. The communication network between the user interface service 205 and the Money Business Service 206 may incorporate security means for user input search requests such as HTTPS, SSL/TLS, and user authentication/authorization using LDAP, SAML, OpenId, or OAUth.

The communication network between the data storages 212, 213, 214 and the User Interface Service 205 may incorporate security means such as SSL, TLS, HTTPS or any other secured means of data transmission. The data storages 212, 213, 214 may comprise relational database(s) such as MySQL, NoSQL database(s) such as Cassandra, HBase and time-series database(s) such as InfluxDB, Graphite. The data storages, running on software layer 200B, each have at least 2 TB of storage space. The data format in data storage may be in human readable form including, but not limited to, XML, JSON, GEOJSON, CSV, TXT.

The total amount received per dollar index value data, stored in storage 213, may be computed as a function of time t using processors 216 for each money service business available pay-in and pay-out option key value pair as shown in Equation 3.

$$[ total amount received per dollar index value ( t ) ] y = \frac{( Exchange Rate ( t ) ) y * ( Amount Sent ) y}{( Amount Sent ) y + ( Transfer Fee ) y} \qquad Equation 3$$

### Where

Exchange Rate(t)y denotes the exchange rate at time t using money services business y,

(Amount Sent)y denotes the amount sent using money services business y,

(Transfer Fee)y denotes the transfer fee associated with amount sent using money services business y.

The total amount received per dollar index value computation may be performed for every pay-in and pay-out value pair option. For example, the processors 216 may look up Money Service Business Name “Western Union®™” pay-in types and pay-out types as follows: for pay-in types: Bank Account, Credit Card, Cash and for pay-out types: Cash Pickup, Bank Deposit, Mobile Wallet, the processors 216 perform the total amount received per dollar index value computation of 9 combinations of pay-in, pay-out value pair as shown below:

<Bank Account, Cash Pickup>, <Bank Account, Bank Deposit>, <Bank Account, Mobile Wallet>, <Credit Card, Cash Pickup>, <Credit Card, Bank Deposit>, <Credit Card, Mobile Wallet>, <Cash, Cash Pickup>, <Cash, Bank Deposit>, <Cash, Mobile Wallet>

The collected money services business data, the computed total amount received per dollar index value data, and the collected market exchange rates data, stored in data stores 212, 213, 214, is sent to the user interface service 205 for display to the client devices 201, 202, 203, 204. Examples of client devices, may include, but are not limited to: a desktop computer(s), a laptop computer(s), IoT (Internet of Things) devices, mobile computing device(s), a server computer, a series of server computers, a mainframe computer(s) or a computing cloud(s). The user interface for data display includes, but not limited to, internet web browser, Graphical User Interface (GUI), Command Line Interface (CLI). The client device communication network connection to the hosting server 200 includes, but is not limited to, wifi, internet, Ethernet, LAN, WAN, Long Term Evolution (cellular).

The real-time data displayed to the client device's user interface may be in a data batch format. The batch of data, for example as shown in Equation 1, may be displayed as data presentation including, but not limited to, map charts, line charts, pie charts, area charts, bubble charts, column bars, clustered bars, bar charts, scattered charts, dynamic charts, 3D charts, tree map, or any combination thereof. The data presentation of the data management system may leverage, for example, the chart js library that provides a rich API (Application Programming Interface) to visualize different types of charts to the client device's user interface. Third-party software tool, such as, Highcharts®™ API may be used for data visualization. The system may also use bootstrap js and bootstrap CSS to handle the responsive web UI across different screen sizes and resolutions of client devices. The data batch may, for example, be displayed as a REST API data format, a tabular data frame, an embeddable HTML code widget or any combination thereof.

The data displayed, for example as shown in Equation 1, may be sent over web sockets in micro-batches and displayed to the client device's user interface. Web sockets communication protocol over a TCP connection on a port enables interaction between a client device's internet web browser and a backend hosting web server. Web sockets facilitate real-time data transfer between the front-end user interface and the backend hosting web server. The hosting server 200 may run a web server(s) including, but not limited to, nginx, Apache, Internet Information Services (IIS), lighttpd to facilitate the data batch dispatch to the client device's user interface. The web server runs on the software layer 200B.

For example, the client device's internet web browser “listens” to the hosting server 200 web server and port number where the micro-batches of data are sent from the data stores 212, 213, 214. Sending micro-batches of data, to a tcp socket port for display on the client device's internet web browser, results in faster reactions to information from the money transfer community using the data management system.

A live dashboard user interface displays real-time data collected from decentralized heterogeneous money service business and market exchange rate data sources. The said dashboard may be used as a tracking and monitoring portal for providing business intelligence around data insights and analysis on ‘pay-per-content’ subscription-based business model. A subscription business model may be employed to monetize the data management system by providing insights through data visualization, analysis and exploration of money services business data and market exchange rate data. Patterns, trends, risk and opportunities may be identified based on the data displayed to the live dashboard. In addition, the data management system integration with money services business servers may provide the ability for the money transfer community to search, compare and send money directly from the data management system. Sending money from the data management platform may entail redirecting the client device's end user session to the money service business server to securely send payments using the money services business servers.

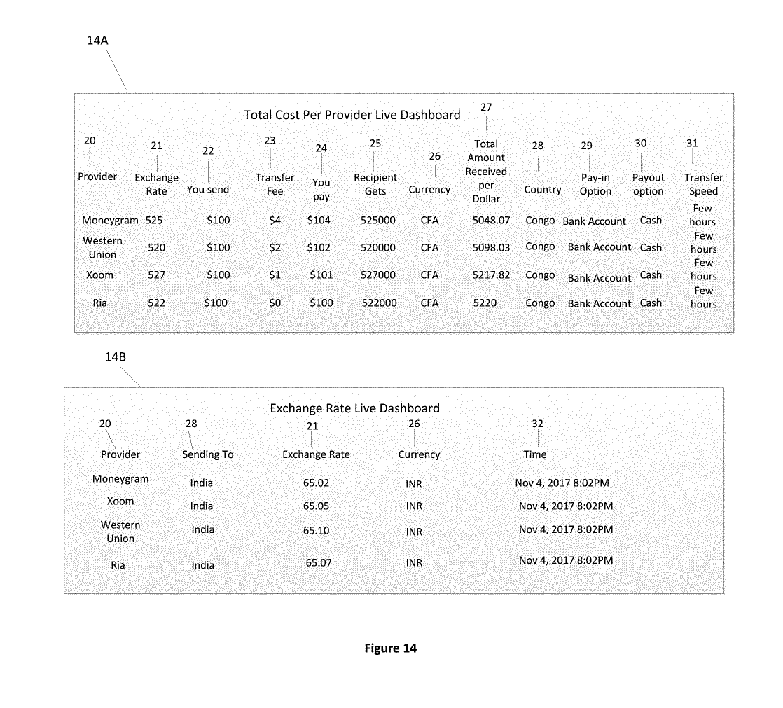

FIG. 14 is an overview live dashboard displaying collected real-time data from decentralized heterogeneous money services businesses servers to the user interface based on input search parameters. The dashboard includes the Total Cost Per Provider Live Dashboard 14A and the Exchange Rate Live Dashboard 14B. The Total Cost Per Provider Live Dashboard 14A displays each money service business collected data in a table format including Provider 20 (money service business name), Exchange Rate 21, You send 22 (amount sent), Transfer Fee 23, You pay 24 (total cost to send), Recipient Gets 25 (amount received), Currency 26 (received currency), Total Amount Received per Dollar 27, Country 28 (destination country), Pay-in Option 29, Payout option 30, Transfer Speed 31. The Exchange Rate Live Dashboard 14B displays exchange rate data information collected from decentralized heterogeneous money services businesses servers. The data displayed includes Provider 20 (money service business name), Sending To 28 (destination country), Exchange Rate 21, Currency 26 (received currency), Time 32.

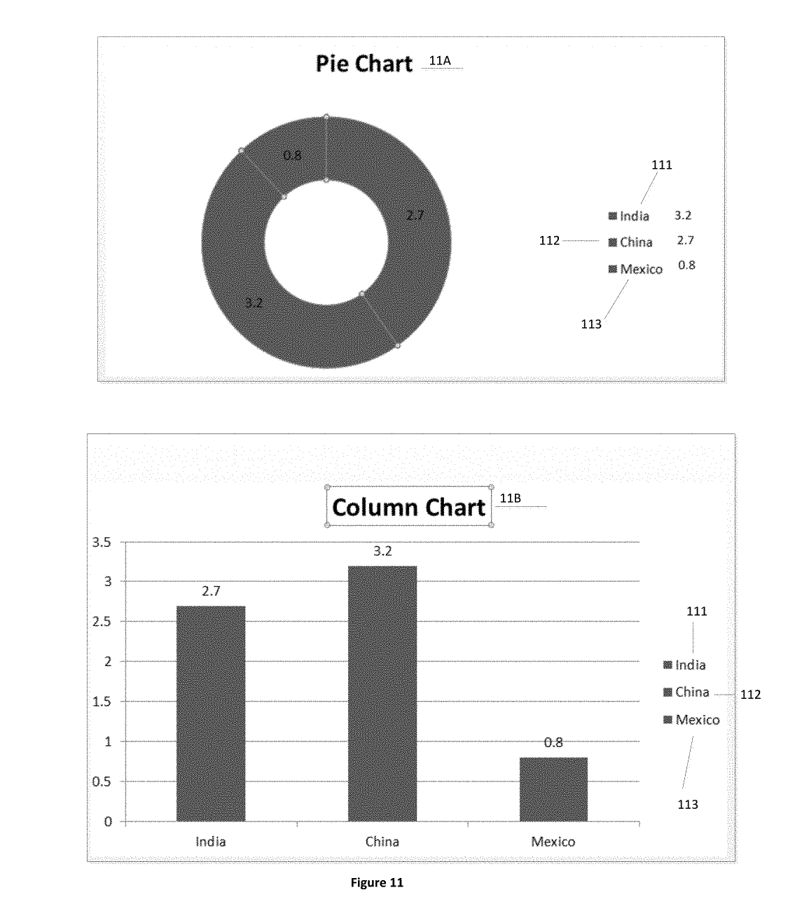

FIG. 11 is an overview live dashboard of data visualization charts of end user requests initiated from the data management system to specific destination countries. The data visualization charts include a Pie Chart 11A and a Column Chart 11B. The Pie Chart 11A depicts the percentage of end user requests initiated from the data management system to destination countries 111, 112, and 113. The column chart 11B depicts the same percentage of end user requests initiated from the data management system to destination countries 111, 112, and 113.

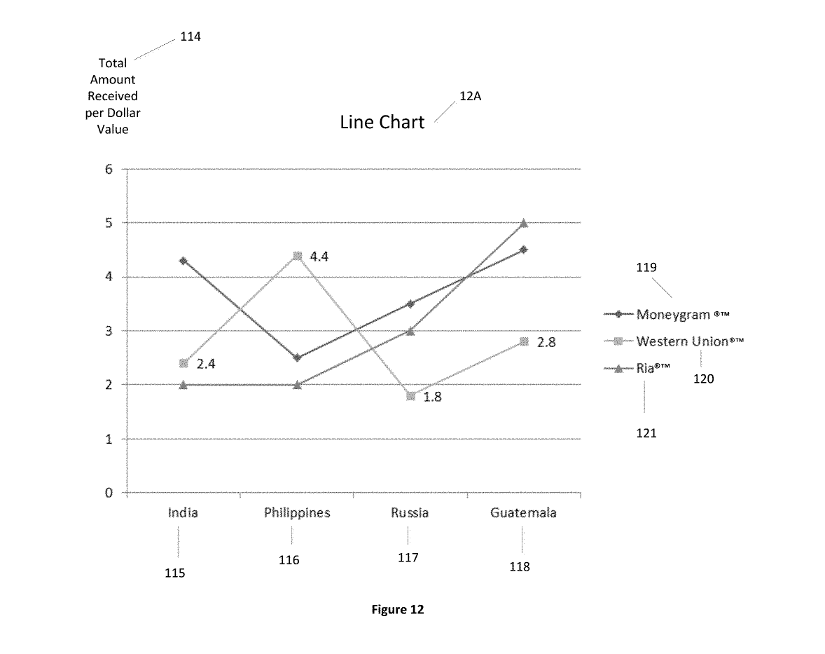

FIG. 12 is an overview live dashboard of data visualization line chart of total amount received per dollar value per specific destination countries for specified money services businesses. The data visualization line chart illustrates line chart 12A of total amount received per dollar value 114 per specific destination countries 115, 116, 117, 118 for specified money services businesses names 119, 120, 121.

The data management system may capture an end user onboarding process (not illustrated) through end user registration, authentication and authorization to submit input search parameters to the system. The data management system may display the relationship between each end user's profile information and the end user's associated input search request parameters values.

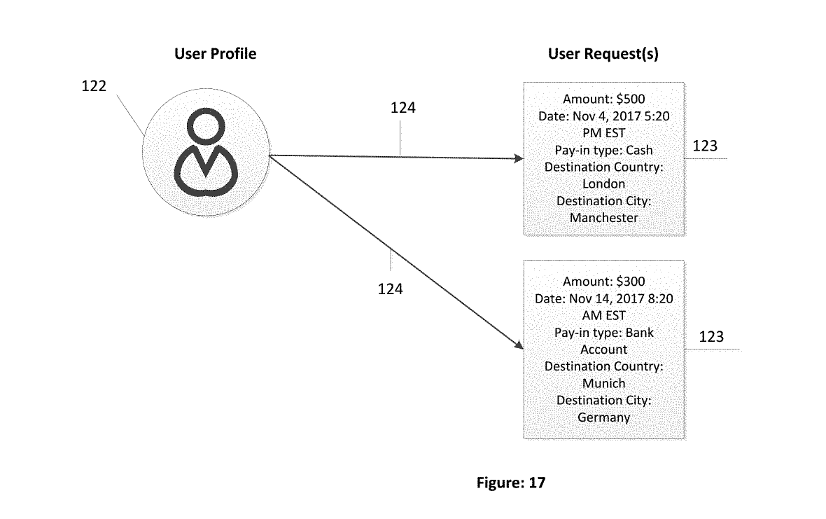

FIG. 17 is an overview live dashboard of graph-data visualization depicting the relationship between an end user's profile and the end user's submitted requests from the data management system. The end user profile's node 122 represents the digital end user's picture. The end user's request(s) nodes 123 represent input search parameters submitted by the end user from the data management system. The directional relationship 124 represents the relationship between end user profile node 122 and the end user's requests nodes 123. The collection of nodes 122, 123 and relationship 124 together form the graph-data structure.

Beyond the above descriptive analytics through real-time data collection, aggregation, storage and displaying of money services businesses data and market exchange rate data; it is desirable to provide a more advanced data management system which provides predictive analytics. The data management system may employ one or more predictive models to predict the money services businesses price movement of total cost to send money within a corridor, total amount received in a destination country, predicted transfer fee associated with sending money within a specific corridor, forecasted exchange rate within a corridor using a specific money services business at a specific time period, and predicted upward or downward trend of the total cost to send for the end user.

The construction and refinement of the predictive model(s) employ scalable machine learning algorithm(s) with set parameters. The data used to train a machine learning algorithm is generally referred as “training data” or collectively a “training data set”. A model is generated from training the machine learning algorithm with training data set. The model is used to predict an outcome (e.g: cost to send money will go up or will go down) while a machine learning algorithm is used to build the model by “learning” the correlation between the inputs and outputs. The predictive model or ‘hypothesis’ hθ is used to predict the values of money service business data such as exchange rate, transfer fee, total cost to send and total amount received. There are several types of predictive models such as classification, regression, clustering. The classification type feeds data to a classifier, for example, a decision tree classifier may determine a binary classification outcome of 0 (false) or 1 (true).

The clustering model type, for example, k-means clusters data to discover similarity or dissimilarity among groups in the data. The regression models such as logistic regression, linear regression, ordinal regression, poisson regression, estimate the relationships among variables. Ensemble machine learning such as random forests, gradient-boosted trees use multiple learning algorithms to obtain better predictive performance. Neural networks are predictive models that capture and represent complex input/output relationships. In linear regression hypothesis, parameters are called features and values are called labels. In neural network hypothesis, parameters are called neurons or layers.

The machine learning may be supervised or unsupervised. In supervised machine learning, the data management system receives a dataset as an input and uses it to make decisions and classifications, from which it infers a mathematical function that maps every element in the input to the output. On the opposite side, unsupervised machine learning is a pure learning process where the data management system must classify and make decisions based only on the sequence of its past actions based on its own hypothesis. For example, k-means data clustering, Naïve Bayes, Principal Component Analysis PCA, Self-organizing maps (SOM) are types of unsupervised machine learning algorithms. Data clustering, for example, is used to understand the dissimilarity of data. It is also used to identify input parameters such as amount, destination country, sending currency and others parameters that are relevant or irrelevant in determining the outcome of the model. Self-Organizing Maps unsupervised machine learning algorithm is used for feature detection. For example, market exchange rate-money services business exchange rate spread could be detected using Self-Organizing Maps based on the market exchange rate and money services business collected data.

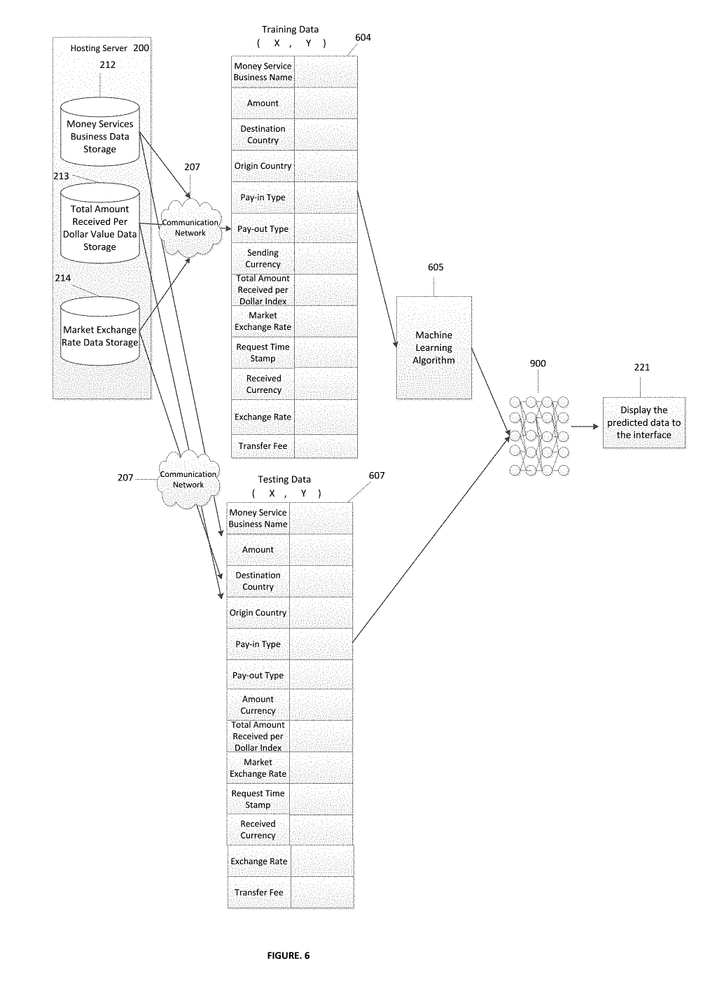

Supervised machine learning requires the output of the predictive model be “labeled”, therefore each feature is a value pair of input (x) and output (y) or {(x,y)} as illustrated in FIG. 6. For example, given a money service business matrix of features: amount, pay-in type, pay-out type, currency, destination country, a resulting outcome may be labeled using a binary output or class (e.g; either total cost to send going “up”; or total cost to send going “down”). The predictive model used to classify the resulting outcome may be called a classifier. A binary classifier is a classifier in which output (y) can take only two values, 0 and 1. For multiple inputs and outputs, the features are called vectors. A matrix of features of input vector “x”, and output vector “y” example is illustrated below in equation 4.

$${}_{ }^{″}{x}{}_{ }^{″} = [ \begin{matrix}200 \\ USD \\ India \\ Moneygram \\ USA \\ Bank Account \\ INR \\ 2017 \text{-} 11 \text{-} 10 \\ 05 \text{:} 20 \text{:} 06 \\ Cash Pickup \\ 65.12 \\ 62.02 \\ 61.42 \\ 2.00\end{matrix} ] \begin{matrix} Amount \\ Sending Currency \\ Destination Country \\ Money Service Business Name \\ Origin Country \\ Pay \text{-} in Type \\ Received Currency \\ Request Time Stamp \\ \\ Pay \text{-} out Type \\ Market Exchange Rate \\ Exchange Rate \\ \begin{matrix} Total Amount Received \\ per dollar index\end{matrix} \\ Transfer Free\end{matrix} \\ and \\ { }_{ }^{″} {y}_{ }^{″} = [ \begin{matrix}0 \\ 1\end{matrix} ] \begin{matrix}Total Cost to send going down \\ Total Cost to send going up\end{matrix} \qquad Equation 4$$

Input vector “x” has thirteen (13) features while the output vector “y” has binary classification outcome with one (1) class: total cost to send classified as one (1) or going up or zero (0) as going down. The binary values of total cost to send in output vector “y” can be derived using deep neural network predictive model. Input vector “x” from equation 4 may contain one or more time-series data as part of the vector. Exchange rate time-series for money service business y is annotated as {Ey(t)}={Ey(t), Ey(t−1), Ey(t−2), . . . , Ey(t−T)} where t is the real valued present time, Ey(t) is the exchange rate sampled at the present time for money service business y, Ey(t−1) is the exchange rate sampled at one sampling period (Δt) in the past for money service business y, Ey(t−2) is the exchange rate sampled at two sampling periods (2Δt) in the past for money service business y and T denotes the total delay elements as we transform a one dimensional time vector into a T-dimensional spatial vector in constructing time-series {Ey(t)}.

Similarly, total amount received per dollar value time-series for money service business y is annotated as {Iy(t)}={Iy(t), Iy(t−1),Iy(t−2), . . . , Iy(t−T)} and market exchange rate time-series is annotated as {M(t)}={M(t), M(t−1), M(t−2), . . . , M(t−T)}. Input vector “x” of equation 4 can potentially take the below form

| | |
|---|---|
| {Xy(t)}={ | {amount}y, |
| | {sending currency}y, |
| | {destination country}y, |
| | {money service business name}y, |
| | {origin country}y, |
| | {pay-in type}y, |
| | {received currency}y, |
| | {request timestamp(t)}, |
| | {pay-out type}y, |
| | {M(t)}, |
| | {Ey(t)}, |
| | {Iy(t)}, |
| | {transfer fee}y |
| } | |

### Where

{amount}y denotes the amount sent using money service business y,

{sending currency}y denotes the sending currency using money service business y,

{destination country}y denotes the destination country using money service business y,

{money service business name}y denotes money service business name y,

{origin country}y denotes origin country using money service business y,

{pay-in type}y denotes pay-in type using money services business y,

{received currency}y denotes received currency using money services business y,

{request timestamp(t)} denotes the request time stamp as a function of t,

{pay-out type}y denotes the pay-out type using money services business y

{M(t)} denotes the market exchange rate as a function of time t

{Ey(t)} denotes the exchange rate as a function of time t using money services business y

{Iy(t)} denotes the total amount received per dollar value as a function of time t using money services business y

{transfer fee}y denotes the transfer fee using money services business y.

The predicted price movements of money services business based on said input vector “x” can be derived using deep neural network predictive model. The new output vector “y” can have five classes namely predicted total cost to send, predicted total amount received at destination, predicted exchange rate, predicted transfer fee and predicted total cost trend (e.g: going up or going down) as illustrated below in equation 5.

$${}_{ }^{″}{x}{}_{ }^{″} = [ \begin{matrix}200 \\ USD \\ India \\ Moneygram \\ USA \\ Bank Account \\ INR \\ 2017 \text{-} 11 \text{-} 10 \\ 05 \text{:} 20 \text{:} 06 \\ Cash Pickup \\ 65.12 \\ 62.02 \\ 61.42 \\ 2.00\end{matrix} ] \begin{matrix}Amount \\ Sending Currency \\ Destination Country \\ Money Service Business Name \\ Origin Country \\ Pay \text{-} in Type \\ Received Currency \\ Request Time Stamp \\ \\ Pay \text{-} out Type \\ Market Exchange Rate \\ Exchange Rate \\ \begin{matrix}Total Amount Received \\ per dollar index\end{matrix} \\ Transfer Free\end{matrix} \\ and \\ { }_{ }^{″} {y}_{ }^{″} = [ \begin{matrix}Predicted Total Cost to Send \\ Predicted Amount Received \\ Predicted Exchange Rate \\ Predicted Transfer Fee \\ Predicted Total Cost Trend\end{matrix} ] \qquad Equation 5$$

output vector “y” can potentially take the form below

| | |
|---|---|
| {Yy(t)}={ | |
| | {predicted Total Cost to Send}y, |
| | {predicted Amount Received}y, |
| | {predicted Ey(t)}, |
| | {predicted Transfer Fee}y, |
| | {predicted Total Cost Trend}y |
| } | |

The production machine learning algorithm may employ one or more models, for example, decision trees to determine the binary classification of total cost to send.

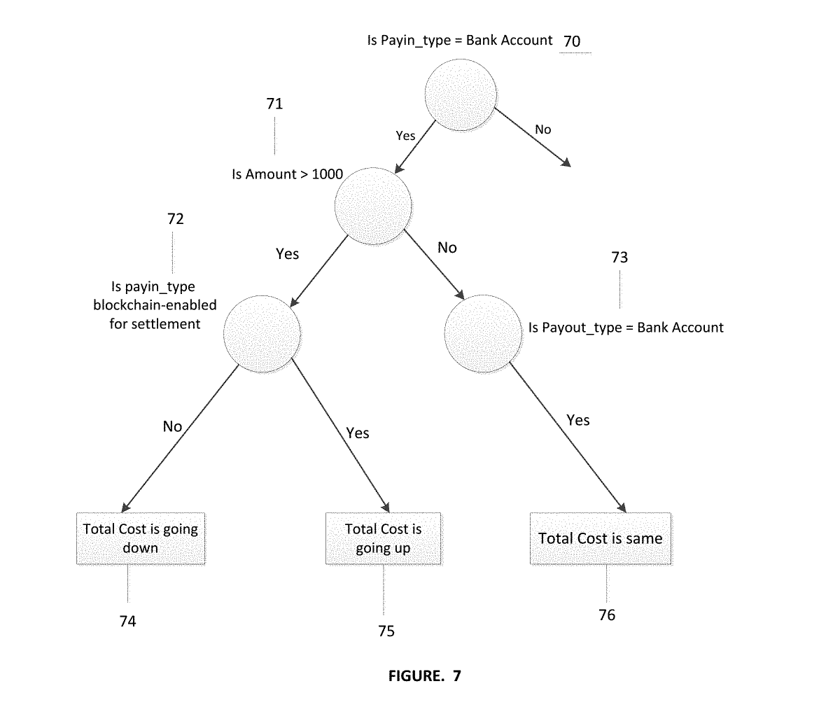

FIG. 7 is a decision tree schematic used for machine learning binary classification. The decision tree implements a set of rules based on a series of questions about the attributes of the input observation. Each time an answer is received, a follow-up question is asked until a conclusion about the class label of the observation is reached. The decision tree includes a root node 70, three internal nodes 71, 72, 73, and three leaves or terminal nodes 74, 75, 76. The root node 70 is “Is Payin_type” and its assigned value is “Bank Account”. The three (3) internal nodes with their assigned values are 71 (“Is Amount>1000”), 72 (“Is payin_type blockchain-enabled for settlement true or false”) and 73 (“Is Payout type=Bank Account”). The three (3) leaves or terminal nodes are 74 (“Total Cost is going down”), 75 (“Total Cost is going up”) and 76 (“Total Cost is same”). This rule-based classifier is static and requires experts' input to define the set of rules to classify outcomes and does not need the training dataset. Therefore, it has a low degree of accuracy and presents some limitations.

Although data mining money services businesses data, and market exchange rates data have a low to medium complexity due to the defined parameters; the structured data response format; and the completeness of data provided from money services businesses servers, data mining still has some constraints. First, it is very labor intensive and time consuming to train a machine learning algorithm. Second, the smaller the input sample size, the less accurate the model therefore the model provides better outcome as the size of the training dataset increases. The machine learning process requires several trial and errors of various algorithms prior to determining the model with a higher degree of accuracy. Training settings may need to be adjusted at times to benchmark several algorithms with specific settings.

To mitigate the decision tree limitations and data mining constraints, the present disclosure employs an online low bias deep neural network that is continuously trained using a real-time production dataset to achieve higher degree of accuracy. Neural networks are class of deep learning algorithms that focus on feature selection and learn what features matter for the problem. It uses data flow diagrams for numerical computations and is composed of neurons, simple building blocks that ‘learn’ from data flowing through them. Each input value to the neuron gets assigned a weight. Bigger weight is assigned to the feature with the biggest impact to the problem.

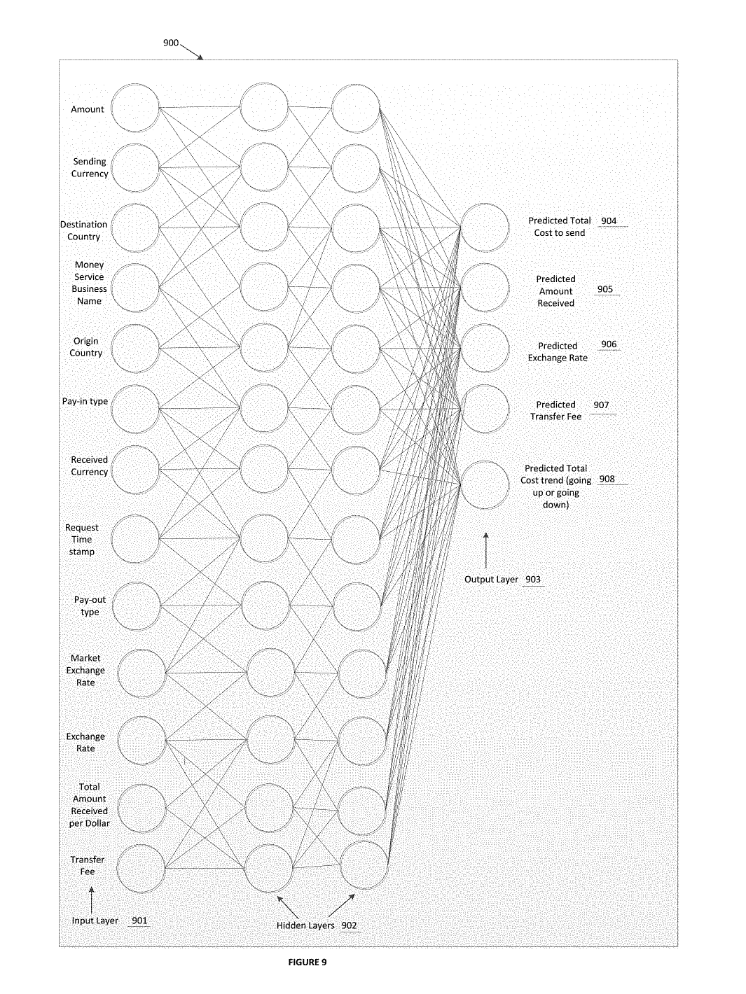

FIG. 9 is an Artificial Neural Network schematic used for deep learning to derive predictive price movements of money services businesses data. As further shown on FIG. 9, the Artificial Neural Network (ANN) 900 includes an input layer 901, hidden layers 902, and output layer 903. The input layer 901 includes a matrix of features, input vector “x” from equation 5. The matrix of features contained in the input layer 901 are amount, sending currency, destination country, money service business name, origin country, pay-in type, received currency, request time stamp, pay-out type, market exchange rate, exchange rate, total amount received per dollar, and transfer fee.

The output layer 903 includes variables output vector “y” from equation 5. The variables contained in the output layer 903 are predicted total cost to send 904, predicted amount received 905, predicted exchange rate 906, predicted transfer fee 907, and predicted total cost trend 908. Each circle represents a neuron; each line has a specific weight that flows the data to the neuron. The supervised machine learning may employ stochastic gradient descent algorithm to repeatedly run through the training set and update the parameters according to the gradient of the error with respect to that training example as with the following algorithm:

```
Loop {
    for i=1 to m, {
        θj := θj + α (y(i) − hθ(x(i))) x(i)j (for every j).
                }
      }
```

Where α denotes the learning rate, h denotes the hypothesis and θ denotes the feature under training.

For example, to build and train the Artificial Neuron Network in FIG. 9 using stochastic gradient descent algorithm, the first step is to randomly initialize the weights to small numbers. Second step is to input the first observation of the dataset, for example, input vector “x” of equation 5 below in the input layer 901 with each feature in one input node as shown on the input layer. Third step is to activate the neurons from left to right (through forward propagation). The deep neural network assumes feed-forward multilayer in neural networks connections similar to Finite Impulse Response (FIR) digital filter. The activation is forward propagated until getting the predicted results 904, 905, 906, 907, 908. Fourth step is to compare the actual values to the predicted values and measure the cost function or error in the prediction as depicted below:

$$Mean Squared Error ( MSE ) = \frac{1}{nSamples} {\sum }_{i = 0}^{nSamples - 1} {( y ( i ) - \hat{y} ( i ) )}^{2}$$

Where ŷ(i) is the predicted value of the ith sample, y(i) is the corresponding actual value of the ith sample and nSamples is the number of samples.

On step five, the said error is back propagated through the network in the opposite direction that allows training the network by adjusting the weights according to how much they are responsible for the error. The learning rate decides by how much the weights are updated. On step six, repeat steps one (1) to five(5) with additional observation and update the weights after each observation. The assumption is that hidden layer neurons 902 apply the rectifier activation function while the output layer neuron 903 applies the sigmoid function for binary classification of the class predicted total cost trend 908; and Softmax function for output layers with the four predicted classes 904, 905, 906, 907. The assumption is that loss function used for binary classification 908 is binary Cross-Entropy while loss function for output layers with classes 904, 905, 906, 907, is categorical Cross-Entropy.

The assumption is uniform sampling and the use of historical and real-time data from money service businesses and market exchange rate data collected over time through input search parameters requests according to the first aspect of the present disclosure. The deep neural network assumes encoding of non-numerical data to numerical data values and non-numerical data is non-ordinal. It is possible to feed back the predictions {y(t)} as part of the input nodes in a recurring neural network architecture similar to Infinite Impulse Response Filter (IIR). Since an Infinite Impulse Response filter contains feedback loops, its output at every step depends on previous outputs and the filter may be implemented recursively with difference equations. The Artificial Neural Network (ANN) 900 is continuously trained using real-time production data from data continuously collected from the money services business data, the total amount received per dollar value index data and the market exchange rates data stores over the network communication network. To build the predictive model, the collected data is split in training data set and testing dataset. The training data set is used to train the predictive model while the testing dataset tests the model and validates its accuracy.

FIG. 6 depicts a schematic diagram illustrating the workflow of splitting the dataset to train and test the machine learning algorithm to derive a model for predictive analytics. The diagram includes real-time data collected from money services businesses in data store 212; total amount received per dollar index data in data store 213, and market exchange rate data in data store 214. The collected data is split in two sets: a training data set 604 and testing data set 607 to facilitate the training and testing of the predictive Artificial Neural Network (ANN) model 900 using machine learning algorithm 605.

The initial algorithm training and testing may take place on remote standalone infrastructure including, but not limited to, laptop computer, desktop computer or a server computer(s). The remote infrastructure may run a virtual environment including, but not limited to, VMware®™ Workstation Pro, Oracle®™ VirtualBox. The virtual environment, for example, may run Linux®™ Operating system with Anaconda package manager and Spyder Integrated Development Environment (IDE) installed. Spyder receives the dataset from the data stores 212, 213, 214 over the communication network 207. Spyder may employ a data connector, for example, mysql connector to import the dataset from data stores 212, 213, 214 over the communication network 207 to the Spyder environment for the training and testing processes. Theano/TensorFlow/Keras/Numpy/Pandas/matplotlib/PyTorch python libraries are installed on virtual environment and imported in Spyder. The assumption is that any missing values from the received data are filled in and non-numerical categorical data encoded.

The incoming data set from the data stores 212, 213, 214 is split to allocate, for example, 70% of the dataset to training data set 604 and 30% to the test data set 607. The predictive Artificial Neural Network model 900 is trained using a scalable production machine learning algorithm 605. The assumption is that feature scaling is applied to ease the high and parallel computations. The model is scored to determine the predicted values' accuracy versus the actual values. To evaluate, improve and tune the trained model 900, k-Fold Cross Validation; dropout regularization to reduce overfitting and parameter tuning may be employed to achieve low bias (or high accuracy) and low variance. Predicted data generated from predictive model 900 is displayed, for example, using python matplotlib as a graph plot to the user interface 221.

These training and testing processes are repeated with both a supervised production machine learning algorithm and unsupervised production machine learning algorithm 605. The supervised production machine learning algorithm 605 may employ at least one technique selected from a group consisting of: (1) linear regression; (2) logistic regression; (3) adaptive logistic regression; (4) support vector machines; (5) Naïve Bayesian classifiers; (6) decision trees; (7) recurrent neural networks; (8) nonlinear autoregressive; (9) radial basis; (10) learning vector quantization algorithms; (11) relevance vector machines; (12) Multiple Kernel Learning.

The unsupervised production machine learning algorithm 605 may employ at least one technique selected from a group consisting of: (1) k-means; (2) principal component analysis; (3) hierarchical clustering; (4) self-organizing maps; (5) fuzzy k-means; (6) Dirichlet distribution; (7) independent component analysis; (8) expectation-maximization; (9) mean-shift; (10) competitive layer neural network; (11) AutoEncoders; (12) Boltzmann Machines.

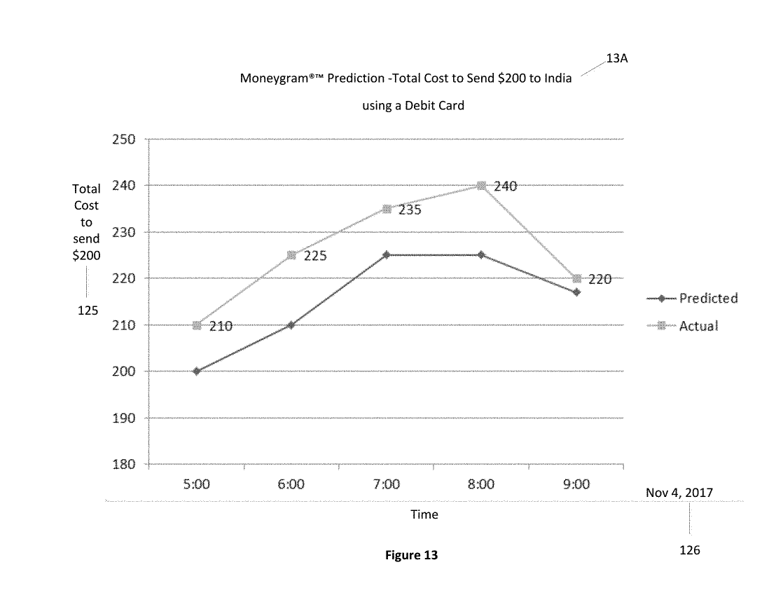

FIG. 13 is an overview of live dashboard data prediction visualization (actual and predicted values) of the total cost to send a specific amount value to a specific country using a specific pay-in type on a specific date. The data prediction visualization 13A illustrates Moneygram®™ prediction (actual and predicted values) of total cost to send 125 to a specific country, for example, India using a specific pay-in type, for example, Debit Card on a specific date 126 at specific time points.

One or more aspects of the data management system have the advantages of providing descriptive, predictive and prescriptive analytics by displaying real-time information to determine the optimal time when the cost of sending money to a destination country from a given money service business is minimized while the total amount received at destination is maximized. The data management system facilitates the decision-making process of the money transfer community in describing, predicting and prescribing the total cost to send, the total amount received at destination, the exchange rate applied, the transfer fee applied to a transaction on a specific corridor for a specific money services business at a time period t. The data management system provides transparency, convenience and cost-effective means to know the potential transaction cost associated with sending money using a money service business provider than to discover the volatility of the money service business costs at the brick-and-mortar point of transaction or on the online money service business platform.

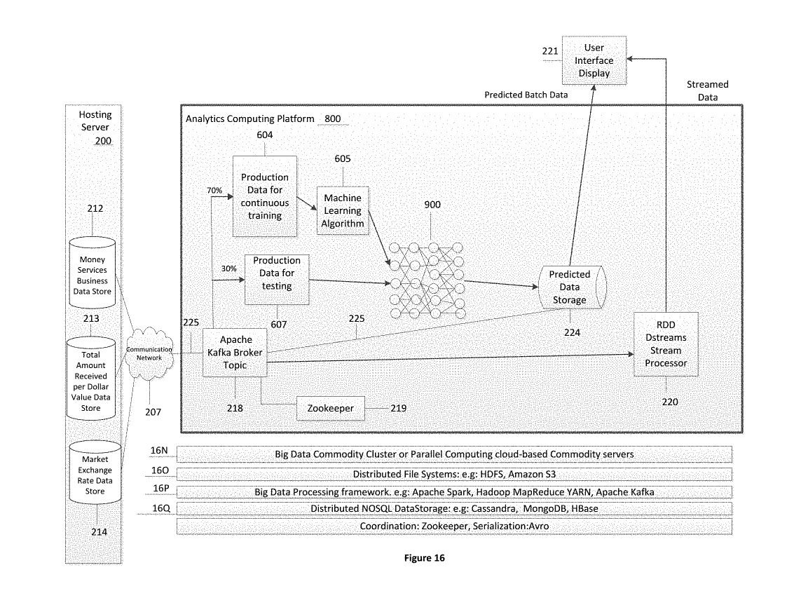

FIG. 16 is a schematic overview of the analytics computing platform illustrating the production machine learning and big data streaming processing aspects. The production analytics computing platform 800 illustrates a diagram of the predictive Artificial Neural Network model 900 deployed to allow real-time production data from data stores 212, 213, 214 over a communication network 207 split and allocated, for example, as 30% of the data 607 for testing and 70% of the data 604 for continuous training to derive the Artificial Neural Network model 900 using machine learning algorithm 605. The analytics computing platform 800 may run on cloud computing framework that is fault-tolerant, loosely coupled, scalable, redundant and deployed distributed data center infrastructures.

The distributed data center infrastructures may be Platform as a Service (Paas) or Infrastructure as a Service (Iaas) from any of the following cloud vendors including Microsoft®™ Azure, Amazon®™ Web Services, Google®™ Compute Engine. The analytics computing platform's infrastructure includes the big data commodity cluster or parallel computing cloud-based commodity servers on layer 16N, the distributed file systems on layer 16O used for storage of machine learning objects, for example, HDFS, Amazon S3. The big data processing framework on layer 16P are, for example, Apache Spark, Hadoop MapReduce YARN, Apache Kafka. The distributed data storage 16Q, for example, NoSQL databases such as Cassandra, HBase. Service coordination instance Zookeeper and serialization with Avro are deployed between layers 16O and 16Q.

The production machine learning engine may use Apache Spark MLlib installed and configured on layer 16P or Hadoop Mahout Machine Learning framework. Spark shell may be installed for interactive data analysis using programming languages such as Python, Scala or using the Spark Web Console. Machine learning algorithms can be developed using, for example, programming languages R, Python. The machine learning algorithms may be built on the Apache Hadoop cloud computing layer 16P. The computing framework may employ Apache Hadoop Map Reduce parallel processing for data processing.

Apache Hadoop is an open source, cost-effective distributed big data framework platform that is scalable, highly fault-tolerant and built on three core components: the MapReduce (MapReduce V2) programming model for parallel processing, the Hadoop Distributed File System (HDFS) and YARN, the resources cluster manager responsible to schedule tasks or jobs. Hadoop runs on commodity clusters. For example, the machine learning engines such as Mahout/Spark MLlib can use the Hadoop MapReduce programming model to perform supervised learning and unsupervised learning for hypothesis continuous training, validation and testing. MapReduce subdivides large datasets into small datasets and process them independently and in parallel by Map tasks that produce (key, value) pairs sent to Reduce Tasks to group them in results. Hadoop YARN is the cluster manager managing tasks. MapReduce defines the type of computation to perform on the data. Batch job is triggered on a cluster using YARN. YARN checks if the nodes on the cluster have resources to run the job and it may store the predicted data result in HDFS and/or in distributed NOSQL data storage.

The derived predicted values from the predictive model may be persisted in data storage 224, for example, NoSQL DB HBase tables, or HDFS and then displayed to the client device's user interface 221. The analytics computing platform 800 also includes data connectors 225; Apache broker topic 218, zookeeper instance 219 and stream processor 220. The data connectors 225 are used to pull the data from data storages 212, 213, 214 from hosting server 200. The Apache broker topic 218 is used to publish the data received from data storages 212, 213, 214. The stream processor 220 consumes the data published on the broker topic 218. Zookeeper instance 219 provides reliable distributed coordination and configuration details on the analytics platform.

As the money services business data is continually collected from decentralized heterogeneous money services businesses servers and stored in storages 212, 214, and computed total amount received per dollar index value stored in data storage 213, the analytics computing platform 800 of the data management system can continuously and continually evolve. A subscription-based business model may be employed to monetize the predictive and prescriptive aspects of the system that offer a number of advantages including transparency, reduced cost and continuous learning. For example, the subscription-based business model may be employed to recommend whether or not a money service business should lower its price based on a competitor's money service business collected data, or market exchange rate collected data on a certain day, time and hour to gain a competitive advantage.

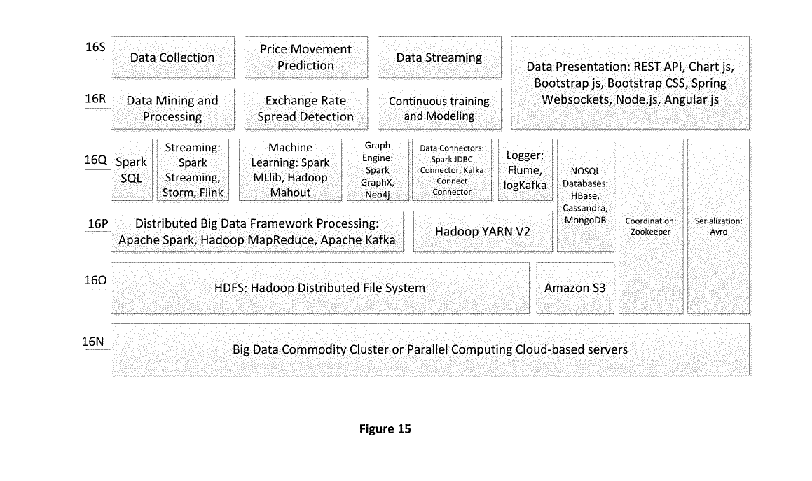

FIG. 15 illustrates a schematic overview of the architecture of the analytics computing platform. The bottom layer 16N provides the example cloud commodity clusters or parallel computing cloud-based servers from cloud vendors' instances, for example, Amazon®™ EMR (Elastic MapReduce). Layer 16O can facilitate the cloud services to store and retrieve data about the static and dynamic components of machine learning objects. Layer 16P facilitates computational services for distributed processing and file system associated with data. The Hadoop cluster may contain security means including, but not limited to Kerberos, Apache Sentry. Equation 5, for example, may be implemented as Java classes, Python packages or C++ shared libraries using machine learning libraries in layer 16Q and enabled by distributed data processing such as MapReduce on Hadoop YARN cluster on 16P.

Apache Spark may be used for repeated access to the same data in-memory on the cluster. Spark is a fast, in-memory data processing engine which allows data workers to efficiently execute streaming, machine learning or SQL workloads that require fast iterative access to datasets. Spark can run on top of Hadoop and can read data directly from the Hadoop Distributed File System (HDFS). HDFS may be used for storing predicted data values in small blocks (e.g. 128 MB) and replicating the blocks in multiple servers with a 64 GB to 128 GB memory per node and at least 2 processors. Several HBase tables between layers 16P and 16Q may provide the data column storage for machine learning tool and predicted data values to analyze. For example, the HBase tables can be organized by column family name with data column names such as Money Service Business, Amount, Origin Country, Destination Country, Pay-in type, Pay-out type, Sending Currency, Market Exchange Rate, request date time stamp, total amount received per dollar index, received currency, exchange rate and transfer fee.

Layer 16Q may include Spark SQL, a SQL-like interface to query the predicted data in data storage, Spark Streaming for streaming the collected and predicted data, Spark MLlib/Mahout for machine learning, graph computation engine GraphX/Neo4j to convert the data in graph structure format, Data connectors to move data from data storages into, for example, Apache Kafka broker topic, logkafka for logging events and NOSQL databases such as Cassandra, MongoDB, HBase for storing the predicted values. Coordination services are provided by Zookeeper and serialization services are provided by Avro between layers 16O and 16Q. Open source java-based RapidMiner Machine Learning software may be used for data mining on layer 16R. Unsupervised machine learning such as Self-organizing Maps may be used for market exchange rate-money services business exchange rate spread detection on layer 16R. Continuous training of the predictive model for relevance may occur on layer 16R.

Web, computer product, IoT (Internet of Things) devices, or mobile user interfaces for data presentation between layers 16R and 16S may be provided for displaying real-time data collection of money services businesses data, market exchange rate data, total amount received per dollar data, and price movement prediction results of money services business data as batch and data stream. Data presentation services may use visualization tools, for example, chart js API library to plot the data including, but not limited to: map charts, line charts, pie charts, area charts, bubble charts, column bars, clustered bars, bar charts, scattered charts, dynamic charts, 3D charts, tree map. Third party software visualization tools such as Tableau®™, Domo®™, PowerBl®™, QlikView®™, Highcharts®™ may be used to visualize the data from the data management system. Other data presentation formats include HTML code widget, batch data format, table data format, REST API format, streaming data format, graph-based data format.

The data may be accessed via REST API (Representation State Transfer Application Programming Interface) using, for example, Fiddler or Google®™ Postman. The data presentation may also use Spring websockets, Node.js, Angular JS for frontend with bootstrap js and bootstrap CSS for responsive web design for accessibility to desktop, IoT (Internet of Things) devices and mobile computing devices. The data management system may employ a big data processing framework, for example Spark Streaming, to stream the collected and predicted data to the client device's user interface. Spark Streaming is an extension of the Apache Spark core component for fault-tolerant processing of live stream data. It is a moderate latency, high throughput and fault-tolerant component running on top of Apache Spark. Apache Spark employs distributed machine learning framework on top of the Resilient Distributed Dataset (RDD) in-memory cluster computing or distributed memory-based cluster computing framework. The streaming process takes place on the analytics computing platform.

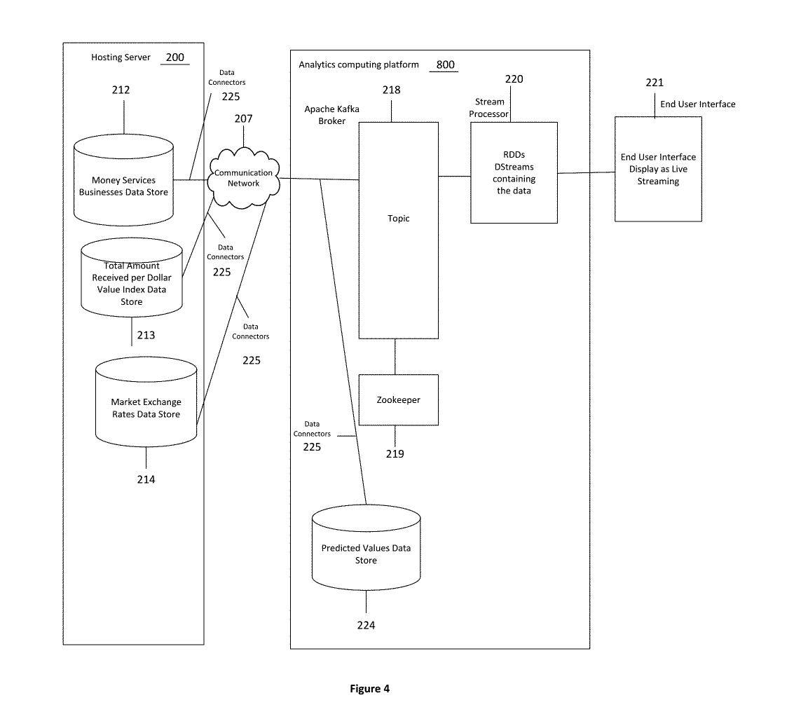

FIG. 4 is a schematic diagram illustrating the process of streaming the money services business data, computed total amount received per dollar value data, predicted price movement data, and market exchange rates data to the user interface. The diagram includes three data stores consisting of the money services business data store 212, total amount received per dollar data store 213 and market exchange rate data store 214 from the hosting server 200. The diagram also includes the predicted values' data store 224 from the analytics computing platform, data connectors 225, a broker topic 218, zookeeper instance 219, a stream processor 220 and user interface 221 for data display to the client device. The predicted values' data store 224, the broker topic 218, the stream processor 220 and the zookeeper instance 219 are hosted on the analytics platform 800.

Data connectors 225, for example, Apache Connect connectors are coupled to the data storages 212, 213, 214, and 224 to publish the data to, for example, Apache Kafka broker topic 218. Apache Kafka is an open source, distributed, high throughput, replicated, fault-tolerant messaging system for connecting disparate sources of data over connectors and moving large amounts of data from data stores to the broker topic using a producer and consumer scheme. Apache Kafka Connect data connectors 225 continuously pull data over communication network 207 from data stores 212, 213, 214, and 224 to publish data on Kafka Broker topic 218. The data connectors 225 may include, but not limited to JDBC, AzurelotHub, Couchbase, IBM Data Replication, Kinetica, SAP HANA, Vertica, Apache Ignite, Blockchain, Cassandra, FTP, Github, MongoDB, Salesforce. The zookeeper instance 219 handles the partitions' coordination across the analytics computing platform 800.

The Stream Processor 220 consumes data published to the topic 218 and streams it real-time to the client device's user interface 221. The stream processor 220 may include the following distributed streaming framework, but not limited to, Microsoft®™ Azure Stream Analytics, Alooma, Spark Streaming, Kafka Streams, MapR Streams, Akka Streams, Apache Storm, Apache Flink, IBMStreams, Samza, Apache Apex. The assumption is that message serialization for data content decoding is done on the stream processor 220.

Apache Stream processor 220 consumes the published data by analyzing the real-time published data using DStreams or Discretized Streams. The stream processor 220 connects as a consumer to the topic 218 and creates Resilient Distributed Datasets (RDDs), a collection of entities made of rows or records. The stream processor 220 sets the published data to pair RDDs rows. Pair RDDs hold a list of key-value pairs data structure of the money services business data, market exchange rate data, predicted price movements data, and total amount received per dollar index value data. For example, a sample java key-value Pair RDD object for money service business data may look as follows:

JavaPairRDD<<String, DateTime>, Iterable<Map<Key, List<obj>>>> where <String, DateTime> denotes the Key.

For example, Key=<Moneygram®™, 20170606055020> Iterable<Map<Key, List<obj>>>> denotes the Value.

Using Equation 1 along with a sample predicted money services data price movement, for example, Value may take the form below:

### Value=map.Put(“Business Name”, “Moneygram®™”)

map.put(“Exchange Rate”,“65.23″)
map.put(“Transfer Fee”,“2”)
map.put(“Amount Sent”,“100”)
map.put(“Sending Currency”,“USD”)
map.put(“Amount Received”,“6523”)
map.put(“Origin Country”,“USA”)
map.put(“Destination Country”,“India”)
map.put(“Receiving Currency”,“INR”)
map.put(“Request Date”,“20171104023012”)
map.put(“pay-in type”,“bank account”)
map.put(“pay-out type”,“cash pickup”)
map.put(“predicted total cost to send”,“103”)
map.put(“predicted amount received”,“6550”)
map.put(“predicted exchange rate”,“65.50”)
map.put(“predicted transfer fee”,“3”)
map.put(“predicted total cost trend”,“up”)

The stream processor 220 performs operations on the published data in memory to extract the useful information depicted above, for example, and de-serializes the data content for display to the client device's user interface 221.

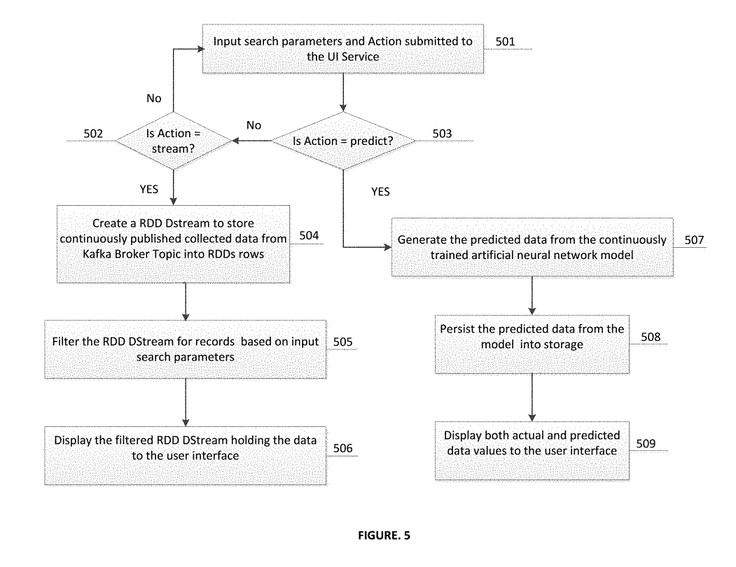

FIG. 5 is a flowchart illustrating the steps taken based on the end user's actions from the data management system. Step 501 illustrates search input parameters and action event submitted to the user input interface service of the data management system. If action ‘predict’ is selected on step 503, the predictive model generates the predicted data based on the continuously trained model as shown in step 507. The predicted data is persisted into storage as shown in step 508. The predicted data and actual data are displayed to the user interface as shown in step 509. The data may be displayed as a data batch or a data stream format. If action ‘stream’ is selected on step 502, Resilient Distributed Datasets (RDDs) store the continuously published data from the Apache Kafka broker topic into rows of RDD DStreams collection as shown in step 504. The RDDs are filtered for relevant records based on the input search parameters in step 505. The filtered RDD DStream holding the data is displayed to the user interface as shown in step 506.

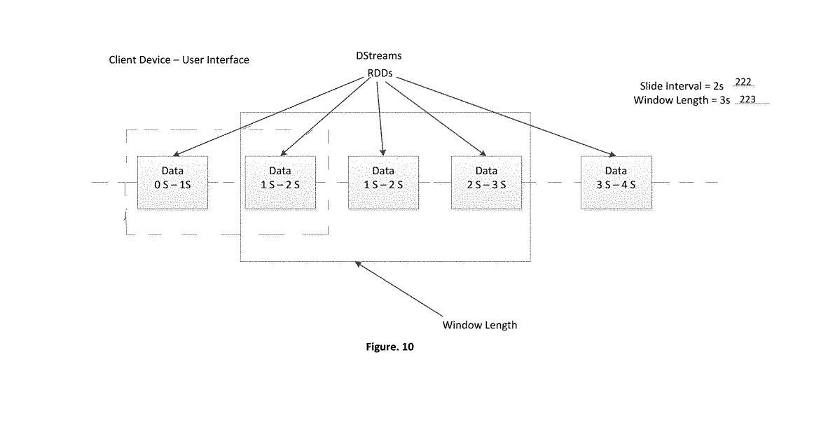

Turning to FIG. 10, the diagram illustrates an overview of RDD DStreams processed and displayed to the client device's user interface. Spark Streaming divides the incoming stream of data into micro-batches of specified slide intervals 222, for example, 2s and treats each batch of data as Resilient Distributed Datasets (RDDs). The result of these Resilient Distributed Datasets (RDDs) returns DStreams. DStream or Discretized Stream represents a continuous stream of data ingested from sources, for example, Apache Kafka broker topic. DStreams are represented as a sequence of RDD objects and are processed and pushed out to the user interface. Spark uses Resilient Distributed Dataset (RDD), which represents a read-only collection of objects partitioned across a set of machines that can be rebuilt if a partition is lost. It should be noted that for illustration purpose a window length 223 of 3s depicts how much data is passed into the display computation. A slide interval 222, for example 2s, may determine the period of time between executions of slide. Although Spark Streaming is used, other open source implementations such as Apache Storm, Apache Pig, Apache Flink, Apache Samza can be used for real-time stream processing on the analytics computing platform.

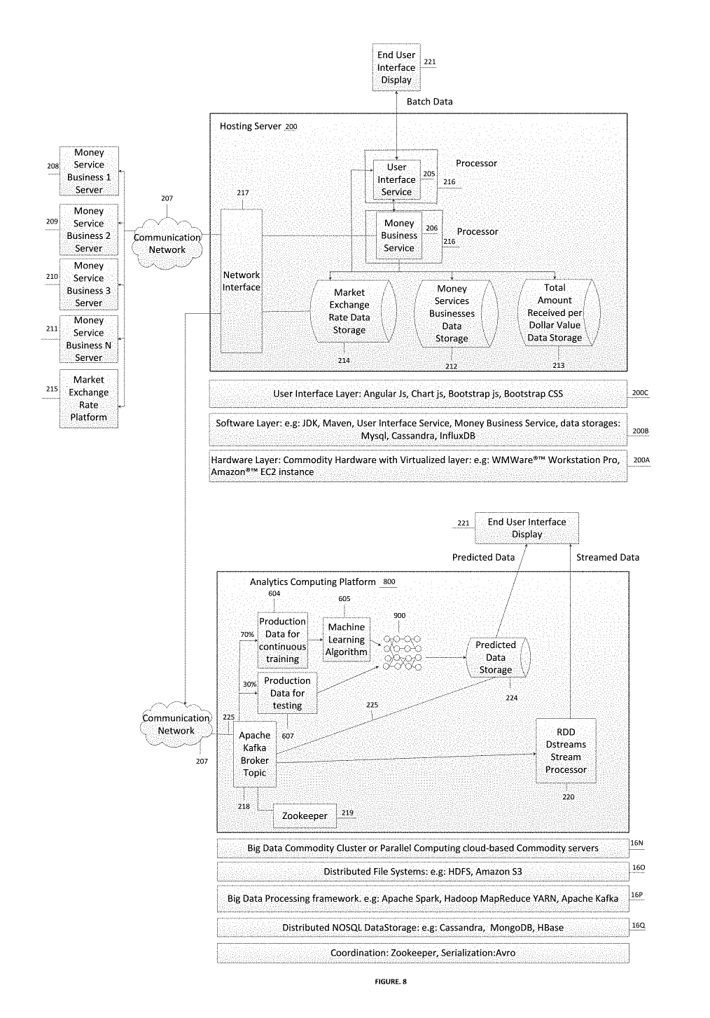

FIG. 8 is a system architecture overview of the data management system. The data management system comprises two subsystems: the hosting server 200 for real-time data collection, aggregation, standardization and storage from external decentralized servers and the analytics computing platform 800 for machine learning predictive analytics and data streaming processing. The hosting server 200 may be hosted on a remote location from the analytics computing platform 800.

The hosting server 200 comprises three layers: the hardware layer 200A, the software layer 200B and the user interface layer 200C. Money Business Service 206, running on layer 200B, communicates with decentralized heterogeneous money services business servers 208, 209, 210, 211 and market exchange rate platform 215 over the communication network 207 using network interface 217. Money Business service 206 collects data from the decentralized heterogeneous money services business servers and market exchange rate platform. The collected data comprises one or more of: money services business name, exchange rate, transfer fee, amount sent, sending currency, amount received, received currency, speed of transfer, money service business geographic pay-out coverage, user reviews, pay-in options, pay-out options, total cost to send, total amount received, request time stamp, market exchange name, market exchange rate, and market exchange rate currency pair (base and quote currencies). The collected data stored in data storages 212, 214, and the computed total amount received per dollar index value data in storage 213 are displayed to the end user interface 221 of the client device(s). The end user interface 221 runs on the user interface layer 200C. End users' profile information captured through user registration, for example, digital picture, may be stored to disk storage on layer 200A.

The hosting server 200 communicates the data from the data storages 212, 213, 214, running on software layer 200B, to the analytics computing platform 800 over a communication network 207 using network interface 217.

The analytics computing platform 800 comprises the big data commodity cluster or parallel computing cloud-based commodity servers 16N, Hadoop Distributed File Systems (HDFS) 16O for storing the machine learning objects, pair RDD streaming objects, big data processing frameworks: Hadoop, Spark, Kafka on layer 16P, distributed storage 16Q for storing predictive data, zookeeper coordination instance 219 and avro serialization between layers 16O and 16Q. Data is ingested from external data sources 212, 213, 214 through data connectors 225 to the distributed messaging system, Kafka Broker topic 218. The ingested data and predicted data, from storage 224, are published to the Apache Broker topic 218 for streaming using, for example, RDD DStreams Stream Processor 220 and displayed to the user interface 221. The data from data sources 212, 213, 214 published on Apache Broker topic 218 are split in two data sets: one for continuous training 604 and the other for testing 607 of the predictive model 900 using production machine learning algorithm 605. Predicted data values from model 900 may be stored in NoSQL data storage 224 and display to the client device's user interface 221. The display user interface comprises one or more of: graphical user interface, web browser interface, command line interface.

Although the above architecture describes an implementation of the analytics computing platform using Apache Hadoop Map Reduce parallel processing cloud architecture, other commercial implementations can be used or considered such as open source Cloudera Enterprise CDH (Cloudera Distribution, including Hadoop), HortonWorks, N2Cloud with ViNNSL neural network paradigm and N2Sky cloud-based Neural Network system.

To increase the depth and dimensionality of the data management system, additional economic data indicators can be collected and incorporated to the embodiments of the present disclosure without departing from the spirit and scope of the present disclosure. For example, geopolitical data (political stability sentiment analysis), economic data (inflation, GDP, unemployment levels, unexpected news, currency devaluation), weather data (natural disasters) pertaining to the destination country, listed in the input search parameters request, may be collected from external systems and stored to the data storages of the hosting server for real-time predictive analysis through the analytics computing platform. The high correlation of these economic data indicators to the destination countries may improve the accuracy and context of the predictive price movements of money services businesses data. Other elements related to the end users of the data management system including digital identities, social trust index, credit worthiness may be collected and used to predict or recommend the personalized price movements of money services businesses based on the end user's digital identity, geo-locations, social trust score, credit score, etc.

Such modifications and other variations may be made to these exemplary embodiments without departing from the scope of the present disclosure.

1. A data management system comprising: first, a scraping method to collect data from one or a plurality of money services business servers (physical, online or both) based on input search parameters; to collect the market exchange rates data from remote market exchange rate platform based on input search parameters; second, determining, using a processor, total amount received per dollar index value data of each money services business based on input search parameters and said collected money services business data; to store in storages data comprising: said collected money services business data, said collected market exchange rates data, said total amount received per dollar index value data; to display one or more of: said collected money services business data, said collected market exchange rates data, said total amount received per dollar index value data; and a communication network communicatively coupled with the storages and an analytics computing platform, wherein the communication network communicates said collected money services business data, said total amount received per dollar index value data, said collected market exchange rates data to said analytics computing platform, wherein the analytics computing platform is facilitated via a cloud computing framework that employs a distributed, fault-tolerant, loosely coupled and scalable file system running on commodity cluster hardware, wherein the analytics computing platform receives said collected money services business data, said total amount received per dollar index value data, said collected market exchange rates data and defines said data as a data set, wherein the data set is sent over a communication network to said analytics computing platform to a messaging system that employs a distributed, high throughput, replicated, fault-tolerant and scalable system running on commodity cluster hardware, wherein the said analytics computing platform employs a production machine learning algorithm to analyze the said data set vis-à-vis a matrix of features to predict money services business data's price movements, wherein the said analytics computing platform employs a big data processing framework to stream the data comprising one or more of: said data set, said predicted money services business data's price movements for display.

2. The data management system of claim 1, wherein the display interface comprising one or more of: graphical user interface, web browser interface, command line interface.

3. The data management system of claim 1, wherein the first scraping method includes collected data of: structured format, semi-structured format, unstructured format or any combination thereof.

4. The data management system of claim 1, wherein the money services businesses servers data sources comprising one or more of: money transfer operator, bank, credit union, loan institution, mobile wallet operator, Bus/Courier Company, Hawala Agent, currency dealers or exchangers, payment solution provider, check cashing provider, post office, issuers or sellers of cryptocurrencies, issuers or sellers of traveler's checks or money orders, blockchain sources, digital financial sources, digital economic sources.

5. The data management system of claim 1, wherein the input search parameters comprising one or more of: destination country, amount sent, sending currency, amount received, receiving currency, destination city.

6. The data management system of claim 1, wherein the collected data comprising one or more of: money service business name, exchange rate, transfer fee, amount sent, sending currency, amount received, received currency, speed of transfer, money service business geographic pay-out coverage, user reviews, pay-in options, pay-out options, total cost to send, total amount received, request time stamp, market exchange name, market exchange rate, and market exchange rate currency pair (base and quote currencies).

7. The data management system of claim 1, wherein the input search parameters comprising one or more of: user configurable input search parameters, system configurable input search parameters.

8. The data management system of claim 1, wherein the data management system data sources are heterogeneous data sources.

9. The data management system of claim 1, wherein the display of data to the interface may employ data presentation types comprising one or more of: map charts, line charts, pie charts, area charts, bubble charts, column bars, clustered bars, bar charts, scattered charts, dynamic charts, 3D charts, tree map, HTML code widget, batch data format, table data format, REST API format, streaming data format, graph-based data format.

10. The data management system of claim 1, wherein said cloud computing framework is a Platform as a Service (Paas) or an Infrastructure as a Service (IaaS).

11. The data management system of claim 1, wherein said cloud computing framework may employ Hadoop Map Reduce parallel processing.

12. The data management system of claim 1, wherein said cloud computing framework may employ a moderate latency, high throughput and fault-tolerant streaming engine.

13. The data management system of claim 1, wherein said cloud computing framework is a platform for managing fault-tolerant, loosely coupled, scalable, redundant and distributed data center infrastructures.

14. The data management system of claim 1, wherein said production machine learning algorithm is a scalable machine learning algorithm.

15. The data management system of claim 1, wherein said production machine learning algorithm is an unsupervised learning algorithm that employs at least one technique selected from a group consisting of: (1) k-means; (2) principal component analysis; (3) hierarchical clustering; (4) self-organizing maps; (5) fuzzy k-means; (6) Dirichlet distribution; (7) independent component analysis; (8) expectation-maximization; (9) mean-shift; (10) competitive layer neural network; (11) AutoEncoders; (12) Boltzmann Machines.

16. The data management system of claim 1, wherein said production machine learning algorithm is a supervised learning algorithm that employs at least one technique selected from a group consisting of: (1) linear regression; (2) logistic regression; (3) adaptive logistic regression; (4) support vector machines; (5) Naïve Bayesian classifiers; (6) decision trees; (7) recurrent neural networks; (8) nonlinear autoregressive; (9) radial basis; (10) learning vector quantization algorithms; (11) relevance vector machines; (12) Multiple Kernel Learning.

17. The data management system of claim 1, wherein the predicted price movement is employed from a group consisting of: (1) machine learning; (2) predictive modeling or analytics; 3) reinforcement learning.

18. A method comprising: first, collecting data from one or a plurality of money services business servers (physical, online or both) based on input search parameters; to collect the market exchange rates data from remote market exchange rate platform based on input search parameters; second, determining, using a processor, total amount received per dollar index value of each money services business based on input search parameters and said collected money services business data; to store in storages data comprising: said collected money services business data, said collected market exchange rates data, said total amount received per dollar index value data; displaying one or more of: said collected money services business data, said collected market exchange rates data, said total amount received per dollar index value data.

19. The method of claim 18, wherein the input search parameters comprising one or more of: destination country, amount sent, sending currency, amount received, receiving currency, destination city.

20. The method of claim 18, wherein the display of data to the interface may employ data presentation types comprising one or more of: map charts, line charts, pie charts, area charts, bubble charts, column bars, clustered bars, bar charts, scattered charts, dynamic charts, 3D charts, tree map, HTML code widget, batch data format, table data format, REST API format, streaming data format, graph-based data format.

21. The method of claim 18, wherein the input search parameters comprising one or more of: user configurable input search parameters, system configurable input search parameters.

22. A method for using a computer processor means for managing data collected from one or a plurality of money services business servers, market exchange rates data platform based on input search parameters, by processing said collected data, by storing the said collected data on a non-transitory computer readable storage medium; determining, using said computer processor means, total amount received per dollar index value data based on input search parameters and said collected data; storing said total amount received per dollar index value data on a non-transitory computer readable storage medium; retrieving from storage medium said collected data, said total amount received per dollar index value data; displaying one or more of: said collected data, said total amount received per dollar index value data.

23. An analytics computing system for processing data comprising one or more of: money services businesses data, total amount received per dollar index value data, market exchange rates data as data set; the analytics computing system comprising: a communication network communicatively coupled with data storages, wherein the communication network is configured to receive, from said data storages, a dataset, said dataset comprising one or more of: said money services business data collected from one or a plurality of money services business servers, total amount received per dollar index value data, market exchange rates data, wherein the data set is sent to said analytics computing platform via a messaging system that employs a distributed, high throughput, replicated, fault-tolerant and scalable system running on commodity cluster hardware over a communication network, wherein the analytics computing system employs a scalable production machine learning algorithm to analyze said data set vis-à-vis a matrix of features to predict money services business data price movements, wherein the said analytics computing platform employs a big data processing framework to stream the data comprising one or more of: said dataset, said predicted money services business data price movements for display.
